(19) United States
(12) Patent Application Publication
(10) Pub. No.: US 2018/0203939 A1
(43) Pub. Date: Jul. 19, 2018

(54) WEB BROWSING APPARATUS AND COMPUTER READABLE MEDIUM

(71) Applicant: MITSUBISHI ELECTRIC CORPORATION, Tokyo (JP)

(72) Inventor: Ken MIYAMOTO, Tokyo (JP)

(73) Assignee: MITSUBISHI ELECTRIC CORPORATION, Tokyo (JP)

(21) Appl. No.: 15/743,786

(22) PCT Filed: Aug. 11, 2015
(86) PCT No.: PCT/JP2015/072733

§ 371 Date: Jan. 11, 2018

(51) Int. Cl. G06F 17/30; G06F 17/18

(52) U.S. Cl. CPC G06F 17/30876; G06F 17/18; G06F 17/30902

(57) ABSTRACT

Each time a link is specified on a transition source page including a plurality of links associated with other web pages, a history registration unit (120) registers specified position information that identifies a specified position on the transition source page in a history file (191). A probability calculation unit (130) calculates, with regard to each page section into which the transition source page is partitioned, a probability that a link included in this page section will be specified, using the specified position information registered in the history file. A page acquisition unit (140) selects a page section based on the probability for each page section, acquires a link included in the selected page section from the transition source page, and acquires a web page associated with the acquired link. A cache unit (150) stores the acquired web page in a cache memory (9011).

### TECHNICAL FIELD

The present invention relates to a technique for prefetching a web page having a high probability of being accessed.

### BACKGROUND ART

Information devices that connect to the Internet using wireless connections are in use. An example of the information devices is a cellular phone.

When a wireless connection is used, the communication conditions vary with the relative positions of an information device and a base station. If the information device is away from the base station, the information device cannot communicate. Even if communication is possible, it takes time to transmit and receive data due to limited bandwidth for communication.

In such a situation where communication is difficult, a technique disclosed in Patent Literature 1 is useful.

Patent Literature 1 discloses the technique in which a prefetch server transmits page data for displaying a web page having a high probability of being accessed by a user to an information device in advance, and the information device caches the web page. If the page data is cached, the time from when an access to the web page is requested to when the web page is displayed is reduced.

This technique is intended for web pages including static links. A static link is a link whose URL (Uniform Resource Locator) does not change.

However, there are web pages including dynamic links. A dynamic link is a link whose URL changes frequently.

For example, a web page such as a news site providing the latest information to users and a web page such as a search site providing information related to keywords input by users are web pages including dynamic links.

In the technique of Patent Literature 1, web pages that are accessed often are cached, so that web pages associated with static links are likely to be cached.

This is because a web page associated with a static link can always be accessed from a web page including a static link, so that the number of accesses is likely to increase.

On the other hand, a web page associated with a dynamic link can be accessed temporarily from a web page including a dynamic link, so that the number of accesses is not likely to increase.

Thus, with the technique of Patent Literature 1, web pages associated with dynamic links are less likely to be cached.

Hence, the technique of Patent Literature 1 is not suitable for web pages associated with dynamic links.

Patent Literature 2 discloses a technique in which a query is predicted using co-occurrence of words in past situations.

If a query corresponding to a keyword having a high probability of being input by a user can be predicted by the technique of Patent Literature 2, it is considered that a web page having a high probability of being accessed by a user can be prefetched.

However, with the technique of Patent Literature 2, it is not possible to predict a query having low co-occurrence with words in past situations.

### CITATION LIST

### Patent Literature

Patent Literature 1: JP 2011-39899 A
Patent Literature 2: JP 2015-509626 A

### SUMMARY OF INVENTION

### Technical Problem

It is an object of the present invention to allow a web page associated with a link having a high probability of being specified to be cached even if URLs indicated by links in web pages change.

### Solution to Problem

A web browsing apparatus according to the present invention includes:
a history registration unit to, each time a link is specified on a transition source page including a plurality of links associated with other web pages, register specified position information that identifies a specified position on the transition source page in a history file;
a probability calculation unit to calculate, with regard to each page section into which the transition source page is partitioned, a probability that a link included in said page section is specified, using the specified position information registered in the history file;
a page acquisition unit to select a page section based on the probability for each page section, acquire a link included in the selected page section from the transition source page, and acquire a web page associated with the acquired link; and
a cache unit to store the acquired web page in a memory.

### Advantageous Effects of Invention

According to the present invention, a probability that a link included in a page section will be specified is calculated with regard to each page section in a web page. Thus, a web page associated with a link having a high probability of being specified can be stored in a cache even if URLs indicated by links change.

### BRIEF DESCRIPTION OF DRAWINGS

FIG. 1 is a functional configuration diagram of a web browsing apparatus 100 according to a first embodiment;

FIG. 2 is a flowchart of a web browsing process (S100) according to the first embodiment;

FIG. 3 is a diagram illustrating an example of the configuration of a home page 200H according to the first embodiment;

FIG. 4 is a diagram illustrating an example of the configuration of the home page 200H according to the first embodiment;

FIG. 5 is a flowchart of a web page display process (S130) according to the first embodiment;

FIG. 6 is a diagram illustrating an example of the configuration of a web page 200 according to the first embodiment;

FIG. 7 is a diagram illustrating an example of the configuration of the web page 200 according to the first embodiment;

FIG. 8 is a configuration diagram of a history file 191 according to the first embodiment;

FIG. 9 is a functional configuration diagram of a history registration unit 120 according to the first embodiment;

FIG. 10 is a flowchart of a history registration process (S140) according to the first embodiment;

FIG. 11 is a diagram illustrating the history file 191 according to the first embodiment;

FIG. 12 is a diagram illustrating the history file 191 according to the first embodiment;

FIG. 13 is a diagram illustrating a map according to the first embodiment;

FIG. 14 is a flowchart of a cache control process (S200) according to the first embodiment;

FIG. 15 is a functional configuration diagram of a probability calculation unit 130 according to the first embodiment;

FIG. 16 is a flowchart of a probability calculation process (S210) according to the first embodiment;

FIG. 17 is a diagram illustrating a parameter model 192M according to the first embodiment;

FIG. 18 is a configuration diagram of the web page 200 according to the first embodiment;

FIG. 19 is a diagram illustrating the parameter model 192M according to the first embodiment;

FIG. 20 is a diagram illustrating a probability parameter file 193 according to the first embodiment;

FIG. 21 is a diagram illustrating a probability file 194 according to the first embodiment;

FIG. 22 is a functional configuration diagram of a page acquisition unit 140 according to the first embodiment;

FIG. 23 is a flowchart of a page acquisition process (S230) according to the first embodiment;

FIG. 24 is a configuration diagram of the web page 200 according to the first embodiment;

FIG. 25 is a diagram illustrating a map according to the first embodiment;

FIG. 26 is a diagram illustrating an example of the configuration of the web browsing apparatus 100 according to the first embodiment;

FIG. 27 is a diagram illustrating changes in a web page 200 according to a second embodiment;

FIG. 28 is a configuration diagram of a web browsing apparatus 100 according to the second embodiment;

FIG. 29 is a diagram illustrating an example of the configuration of a home page 200H according to the second embodiment;

FIG. 30 is a diagram illustrating an example of the configuration of a web page 200 according to the second embodiment;

FIG. 31 is a diagram illustrating an example of the configuration of the web page 200 according to the second embodiment;

FIG. 32 is a diagram illustrating a history file 191 according to the second embodiment;

FIG. 33 is a flowchart of a cache control process (S200) according to the second embodiment;

FIG. 34 is a functional configuration diagram of a section selection unit 160 according to the second embodiment;

FIG. 35 is a flowchart of a section selection process (S250) according to the second embodiment;

FIG. 36 is a diagram illustrating a group information file 195 according to the second embodiment;

FIG. 37 is a diagram illustrating a common identifier set file 196 according to the second embodiment;

FIG. 38 is a diagram illustrating a target identifier file 197 according to the second embodiment;

FIG. 39 is a diagram illustrating a parameter model 192M according to the second embodiment;

FIG. 40 is a diagram illustrating a probability file 194 according to the second embodiment;

FIG. 41 is a diagram illustrating an example of the configuration of a web page 200 according to the second embodiment;

FIG. 42 is a diagram illustrating an example of a hierarchical structure of section identifiers according to the second embodiment; and

FIG. 43 is a diagram illustrating an example of the configuration of the web browsing apparatus 100 according to the second embodiment.

### DESCRIPTION OF EMBODIMENTS

### First Embodiment

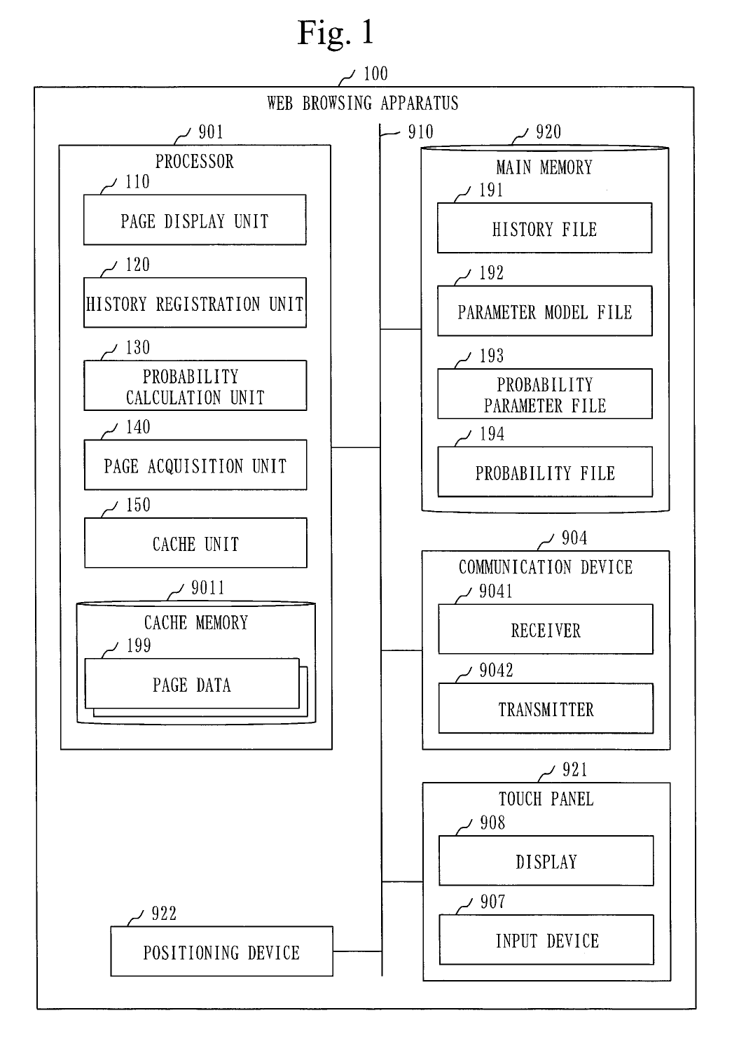

A web browsing apparatus 100 that prefetches and stores in a cache a web page having a high probability of being browsed will be described with reference to FIG. 1 to FIG. 26.

***Description of Configuration***

The configuration of the web browsing apparatus 100 will be described with reference to FIG. 1.

The web browsing apparatus 100 is a computer that has hardware such as a processor 901, a main memory 920, a communication device 904, a touch panel 921, and a positioning device 922. Specifically, the web browsing apparatus 100 is a portable device such as a smart phone or a tablet computer.

The processor 901 is connected with the other hardware via a signal line 910.

The processor 901 is an IC (Integrated Circuit) that performs processing and controls the other hardware. The processor 901 has a cache memory 9011. Specifically, the processor 901 is a CPU, a DSP, or a GPU. CPU is an abbreviation for Central Processing Unit. DSP is an abbreviation for Digital Signal Processor. GPU is an abbreviation for Graphics Processing Unit.

The main memory 920 is a storage device to store data. Specifically, the main memory 920 is a RAM (Random Access Memory).

The communication device 904 has a receiver 9041 to receive data and a transmitter 9042 to transmit data. Specifically, the communication device 904 is a communication chip or a NIC (Network Interface Card).

The touch panel 921 has a display 908 to display data and an input device 907 used for input of data. The display 908 is a display device, and is specifically an LCD (Liquid Crystal Display).

The positioning device 922 is a device to measure the current location of the web browsing apparatus 100. Specifically, the positioning device 922 is a GPS receiver. GPS is an abbreviation for Global Positioning System.

The cache memory 9011 stores page data 199 which is data indicating the content of a web page.

The main memory 920 stores data that is used, generated, or input and output in the web browsing apparatus 100. Specifically, the main memory 920 stores a history file 191, a parameter model file 192, a probability parameter file 193, a probability file 194, and the like. The details of each file will be described later.

The main memory 920 also stores an OS (Operating System).

Further, the main memory 920 stores a program to implement the function of each “unit” such as a page display unit 110, a history registration unit 120, a probability calculation unit 130, a page acquisition unit 140, and a cache unit 150. The program to implement the function of each “unit” can be stored in a storage medium. The function of each “unit” will be described later.

The processor 901 executes the program to implement the function of each “unit” while executing the OS. That is, the program to implement the function of each “unit” is loaded into the main memory 920 and is executed by the processor 901.

Note that the web browsing apparatus 100 may have a plurality of processors 901, and the plurality of processors 901 may execute the program to implement the function of each “unit” in cooperation.

The processor 901 and the main memory 920 will be referred to collectively as “processing circuitry”.

Each “unit” may be interpreted as a “step”, a “procedure”, or a “process”.

***Description of Operation***

The operation of the web browsing apparatus 100 corresponds to a web browsing method. The web browsing method corresponds to a processing procedure of a web browsing program.

The web browsing method has a web browsing process (S100) and a cache control process (S200).

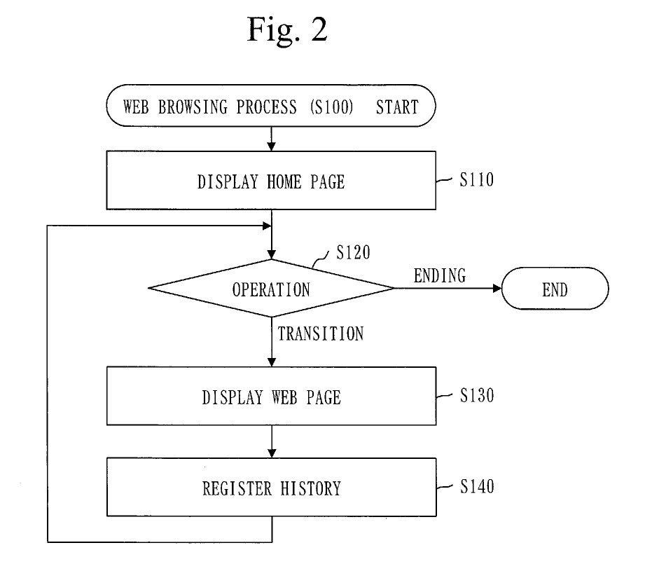

The web browsing process (S100) will be described with reference to FIG. 2.

The web browsing process (S100) is executed after the page display unit 110 is activated. Specifically, the page display unit 110 is a web browser.

The processes of S110 to S130 executed by the page display unit 110 are the same as the processes executed by a conventional web browser.

S110 is a home page display process.

In S110, the page display unit 110 acquires data of a home page from a web server, and displays the home page on the display 908 using the acquired data.

The home page display process (S110) is the same as the process executed by the conventional web browser, and thus a detailed description of the process will be omitted.

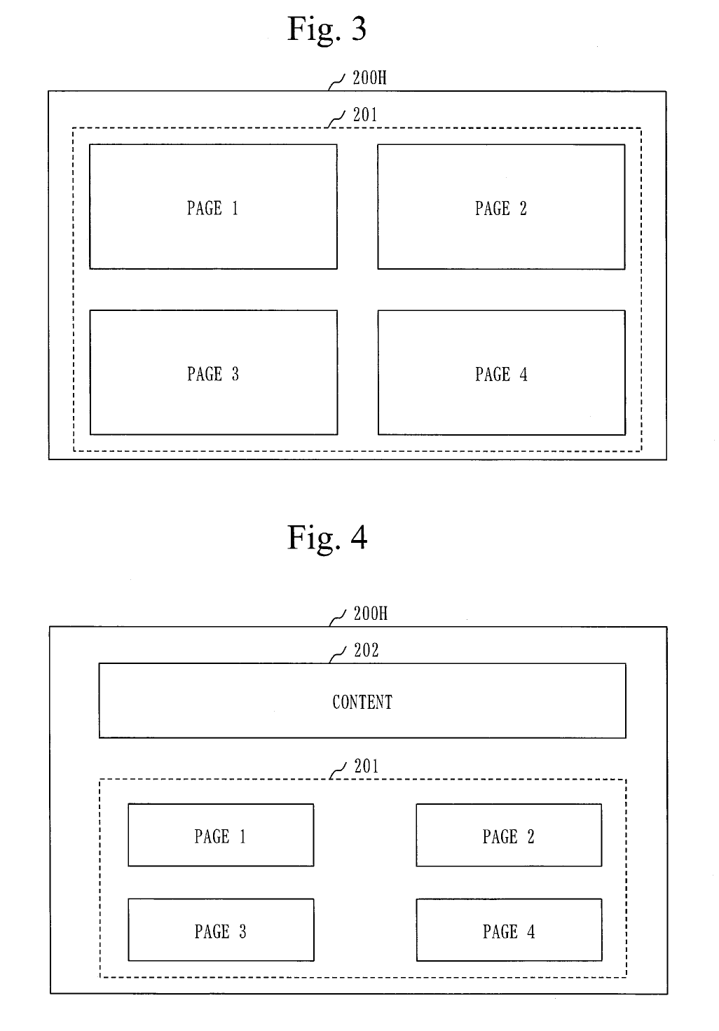

FIG. 3 and FIG. 4 illustrate examples of the configuration of a home page 200H.

In FIG. 3, the home page 200H has four links 201. The form of each link 201 is a button. A button functioning as the link 201 will be referred to as a transition button. A transition button marked as page x functions as a link associated with a web page identified by an identifier called page x.

In FIG. 4, the home page 200H has content 202 in addition to four links 201. The content 202 is data displayed in order to be provided to a user. Specifically, the content 202 is a text, an image, or a video.

The link 201 can be configured in a form other than a button, such as a character string or an image.

Referring back to FIG. 2, the description continues from S120.

S120 is an operation determination process.

In S120, the page display unit 110 determines the type of an operation performed on the displayed web page.

Note that an operation to make a transition from a web page will be called a transition operation, and an operation to end browsing of a web page will be called an ending operation.

Specifically, the transition operation is specifying a link, which is an operation to specify a link 201, or executing a search, which is an operation to execute a search. Specifying a link is an operation, on the touch panel 921, to tap on a portion where the link 201 is displayed. If a mouse is connected to the web browsing apparatus 100, an operation to place a mouse cursor over the link 201 and click on the link 201 with the mouse is specifying a link. Executing a search is an operation, on a web page having a search window and a search button, to input a search keyword in the search window and depress the search button. The search button is depressed by tapping or clicking.

Specifically, the ending operation is an operation to depress an end button in a window having a display section where a web page is displayed. Normally, the end button is a button marked with an X and is placed at the upper right corner of the window. The end button is depressed by tapping or clicking.

The operation determination process (S120) is a process implemented by a function provided in the conventional web browser, and thus a detailed description of the operation determination process (S120) will be omitted. The processes for when other operations are performed, such as scrolling the screen, are also conventional functions, and thus a description will be omitted.

If the transition operation is performed, the process proceeds to S130.

If the ending operation is performed, the web browsing process (S100) ends.

S130 is a web page display process.

In S130, the page display unit 110 displays a transition destination web page on the display 908.

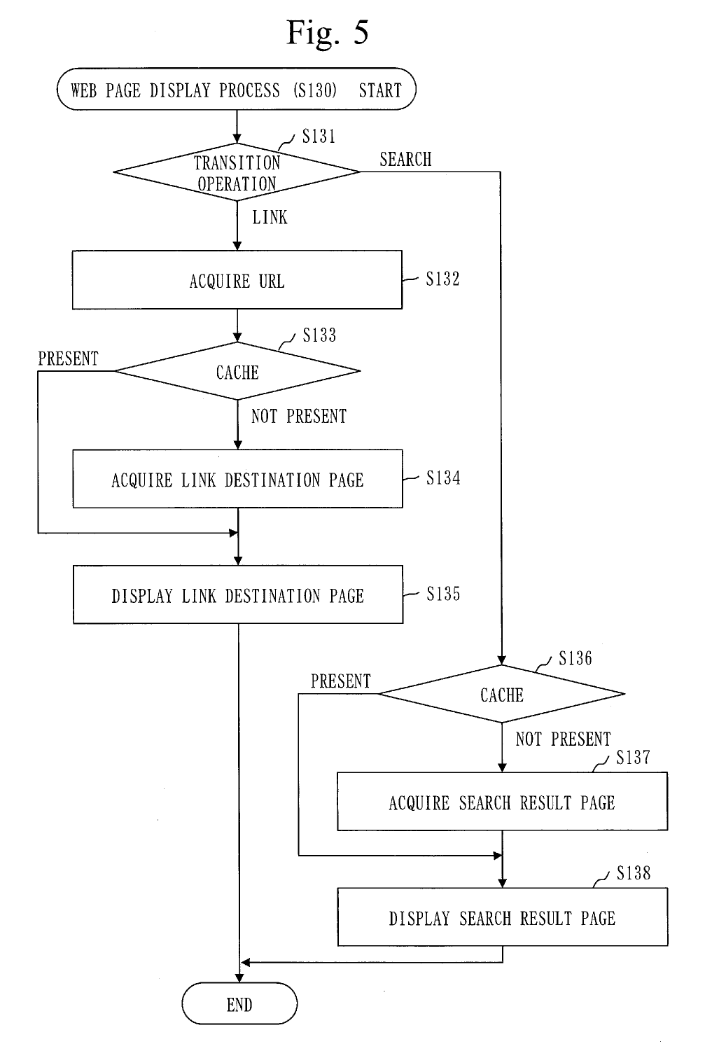

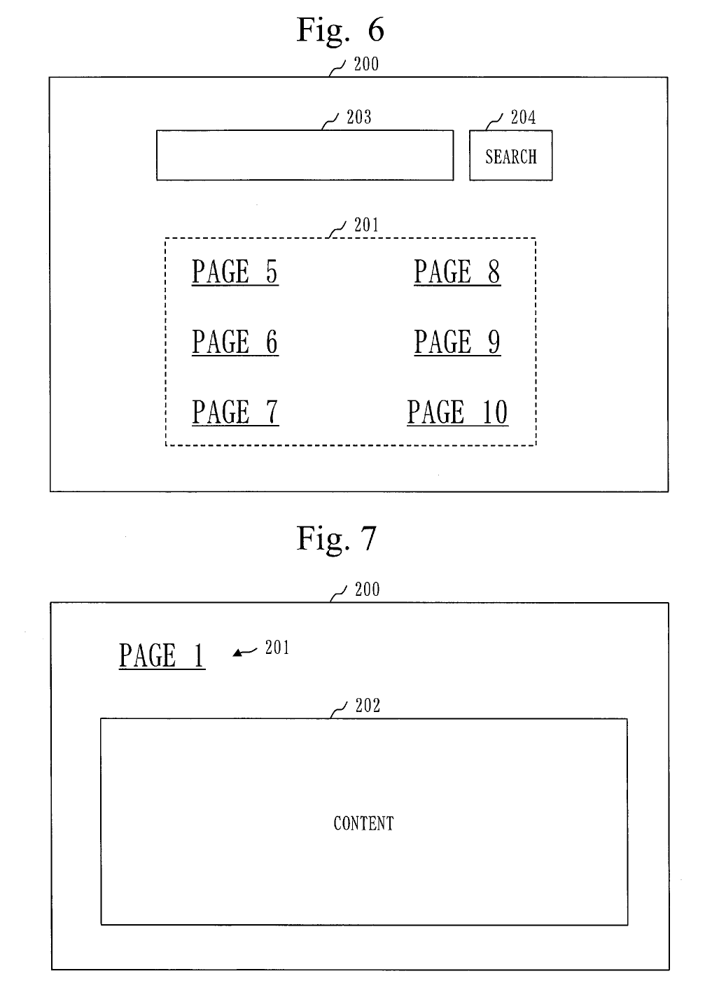

The web page display process (S130) will be described in detail with reference to FIG. 5 and FIG. 6.

In S131, the page display unit 110 determines the type of the transition operation.

If the transition operation is specifying a link, the process proceeds to S132.

If the transition operation is executing a search, the process proceeds to S136.

In S132, the page display unit 110 acquires a URL (Uniform Resource Locator) which is set to the specified link 201 from the web page being displayed. The acquired URL will be called a link destination URL.

In S133, the page display unit 110 refers to the cache memory 9011 and determines whether page data 199 associated with the link destination URL is stored in the cache memory 9011.

If the page data 199 associated with the link destination URL is stored in the cache memory 9011, the process proceeds to S135.

If no page data 199 associated with the link destination URL is stored in the cache memory 9011, the process proceeds to S134.

In S134, the page display unit 110 acquires data of a web page identified by the link destination URL from the web server.

S134 is the same as the process executed by the conventional web browser, and thus a detailed description of the process will be omitted.

The web page identified by the link destination URL will be called a link destination page.

In S135, the page display unit 110 displays the link destination page on the display 908, using the page data 199 stored in the cache memory 9011 or the data acquired from the web server.

After S135, the web page display process (S130) ends.

FIG. 6 and FIG. 7 illustrate examples the configuration of a web page 200.

In FIG. 6, the web page 200 has a search window 203, a search button 204, and six links 201. The form of each link 201 is a character string.

The search window 203 is an input field in which a search keyword is input. The search button 204 is a button to be depressed when a search is performed using the search keyword input in the search window 203.

For example, if the transition button of page 1 is depressed on the home page 200H of FIG. 3 or FIG. 4, the web page 200 of FIG. 6 is displayed.

In FIG. 7, the web page 200 has a link 201 and content 202. Specifically, the content 202 is a text document.

For example, if the link 201 of any one of pages 5 to 10 is tapped on the web page 200 of FIG. 6, the web page 200 having the configuration illustrated in FIG. 7 is displayed.

Referring back to FIG. 5, the description continues from S136.

In S136, the page display unit 110 refers to the cache memory 9011, and determines whether page data 199 associated with the search keyword is stored in the cache memory 9011.

If the page data 199 associated with the search keyword is stored in the cache memory 9011, the process proceeds to S138.

If no page data 109 associated with the search keyword is stored in the cache memory 9011, the process proceeds to S137.

In S137, the page display unit 110 acquires data of a web page containing information regarding the search keyword from the web server.

S137 is the same as the process executed by the conventional web browser, and thus a detailed description of the process will be omitted.

The web page containing information regarding the search keyword will be called a search result page.

In S138, the page display unit 110 displays the search result page on the display 908, using the page data 199 stored in the cache memory 9011 or the data acquired from the web server.

For example, if a search keyword is input in the search window 203 and then the search button 204 is depressed on the web page 200 of FIG. 6, the web page 200 having the configuration illustrated in FIG. 7 is displayed. In this case, a text document indicating information regarding the search keyword is displayed as the content 202.

After S138, the web page display process (S130) ends.

Referring back to FIG. 2, the description continues from S140.

S140 is a history registration process.

In S140, each time a link is specified on a transition source page including a plurality of links associated with other web pages, the history registration unit 120 registers specified position information that identifies the specified position on the transition source page in the history file 191. The transition source page is a web page including a plurality of links associated with other web pages.

Specifically, the history registration unit 120 registers coordinate values indicating the specified position on the transition source page in the history file 191, as the specified position information.

With regard to the transition source page, it is assumed that a web page having a search window in which a search keyword is input is the transition source page.

If specified location information which identifies a specified location is input in the search window as a search keyword and then a search is performed, the history registration unit 120 registers coordinate values indicating the specified location identified by the input specified location information and coordinate values indicating the measured current location in the history file 191. The specified location is a spot identified by the search keyword.

After S140, the process returns to S120.

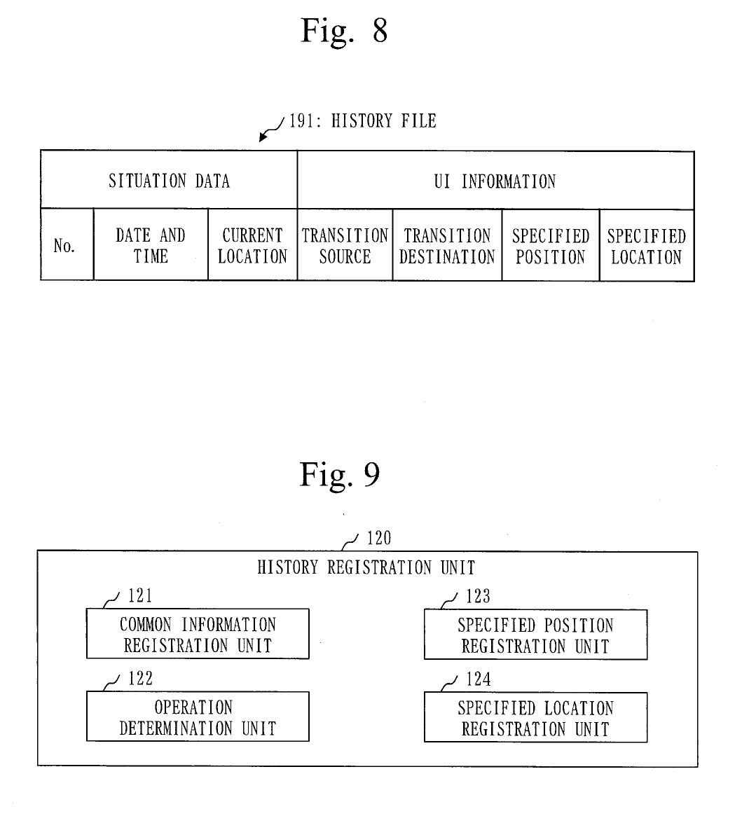

The history file 191 will be described with reference to FIG. 8.

The history file 191 is a file in which situation data and UI information are associated with each other. UI is an abbreviation for User Interface.

The situation data consists of No., a date and time, and an existing location. The UI information consists of a transition source, a transition destination, a specified position, and a specified location.

The No. column indicates a number that identifies the situation data and the UI information.

The date and time column indicates a date and time when the history registration process (S140) is executed, as a date and time when a transition operation is performed.

The current location column indicates current location information which identifies the location of the web browsing apparatus 100 at the date and time when the transition operation is performed. Specifically, the current location information is three-dimensional coordinate values.

The transition source column indicates a URL of a transition source page.

The transition destination column indicates a URL of a transition destination page. Specifically, the transition destination page is a link destination page or a search result page.

The specified position column indicates specified position information which identifies a specified position on the transition source page. Specifically, the specified position information is two-dimensional coordinate values on the transition source page.

The specified location column indicates specified location information which identifies a specified location. Specifically, the specified location information is three-dimensional coordinate values which identify the specified location or a place name which identifies a place including the specified location.

The functional configuration of the history registration unit 120 will be described with reference to FIG. 9.

The history registration unit 120 has a common information registration unit 121, an operation determination unit 122, a specified position registration unit 123, and a specified location registration unit 124.

The common information registration unit 121 registers information on each of No., the date and time, the current location, the transition source, and the transition destination in the history file 191.

The operation determination unit 122 determines the type of the transition operation.

If the transition operation is specifying a link, the specified position registration unit 123 registers the specified position information in the specified position column of the history file 191.

If the transition operation is executing a search, the specified location registration unit 124 registers the specified location information in the specified location column of the history file 191.

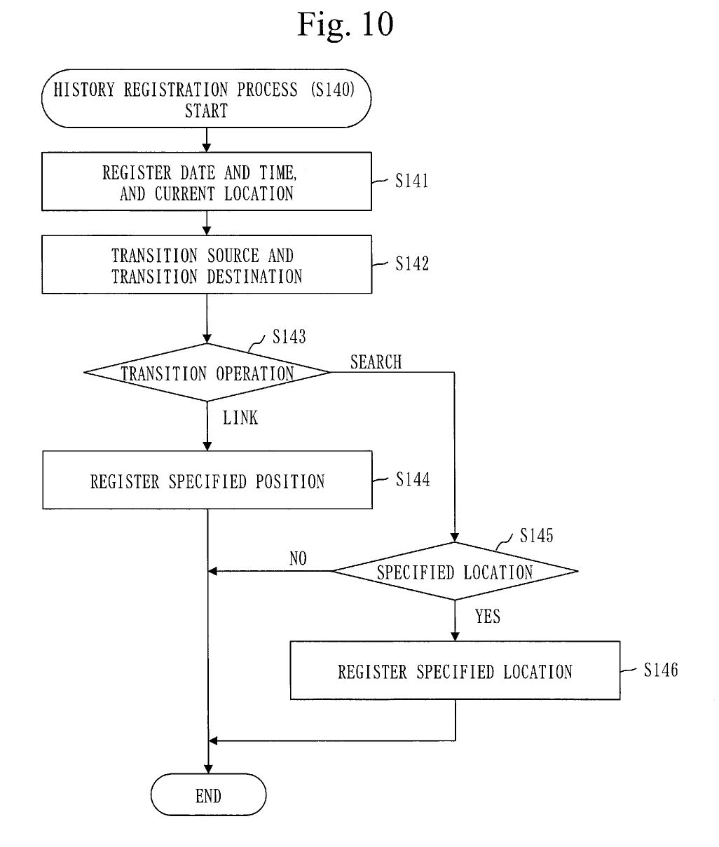

The history registration process (S140) will be described in detail with reference to FIG. 10.

In S141, the common information registration unit 121 acquires the current date and time from the OS, and registers the acquired date and time in the date and time column of the history file 191.

Further, the common information registration unit 121 acquires coordinate values indicating the current location of the web browsing apparatus 100 from the positioning device 922, and registers the acquired coordinate values in the current location column of the history file 191.

In S142, the common information registration unit 121 acquires the URL of the transition source page and the URL of the transition destination page from the page display unit 110.

Then, the common information registration unit 121 registers the acquired URL of the transition source page in the transition source column of the history file 191, and registers the acquired URL of the transition destination page in the transition destination column of the history file 191.

In S143, the operation determination unit 122 acquires information indicating the type of the transition operation from the page display unit 110. Then, the operation determination unit 122 determines the type of the transition operation based on the acquired information.

If the transition operation is specifying a link, the process proceeds to S144.

If the transition operation is executing a search, the process proceeds to S145.

In S144, the specified position registration unit 123 acquires coordinate values that identify the specified position on the transition source page from the page display unit 110, and registers the acquired coordinate values in the specified position column of the page display unit 110.

After S144, the history registration process (S140) ends.

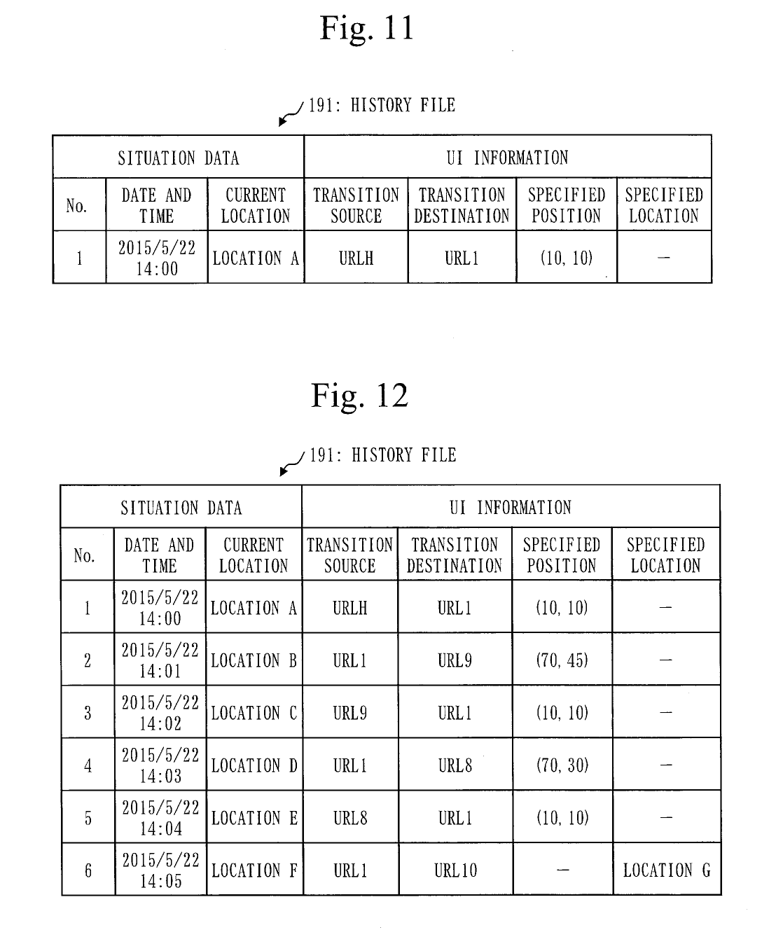

FIG. 11 illustrates an example of the situation data and the UI information which are registered in the history file 191.

The No. 1 row of the history file 191 signifies that a link was specified at location A at 14:00 on May 22, 2015. Further, the No. 1 row signifies that the link placed at the position identified by coordinate values (10, 10) was specified on the web page identified by URLH, thereby causing the web page identified by URL1 to be displayed.

Referring back to FIG. 10, the description continues from S145.

In S145, the specified location registration unit 124 determines whether the format of the search keyword coincides with the format of coordinate values. If the format of the search keyword coincides with the format of coordinate values, the executed search is a search for a specified location.

If the format of the search keyword coincides with the format of coordinate values, the process proceeds to S146.

If the format of the search keyword does not coincide with the format of coordinate values, the specified location registration unit 124 determines whether the same place name as the search keyword is registered in a place name file. The place name file is a file in which a place name and coordinate values are associated with each other and which is pre-stored in the main memory 920. Specifically, the place name file is map data. If the same place name as the search keyword is registered in the place name file, the executed search is a search for a specified location.

If the same place name as the search keyword is registered in the place name file, the specified location registration unit 124 acquires the coordinate values associated with the same place name as the search keyword from the place name file. Then, the process proceeds to S146.

If the same place name as the search keyword is not registered in the place name file, the history registration process (S140) ends.

In S146, the specified location registration unit 124 registers the coordinate values indicated by the search keyword or the coordinate values acquired from the place name file in the specified location column of the history file 191.

After S146, the history registration process (S140) ends.

FIG. 12 illustrates an example of the situation data and the UI information which are registered in the history file 191.

The No. 6 row of the history file 191 signifies that an operation to search for location G was performed at location F at 14:05 on May 22, 2015. Further, the No. 6 row signifies that the search for location G was performed on the web page identified by URL1, thereby causing the web page identified by URL10 to be displayed.

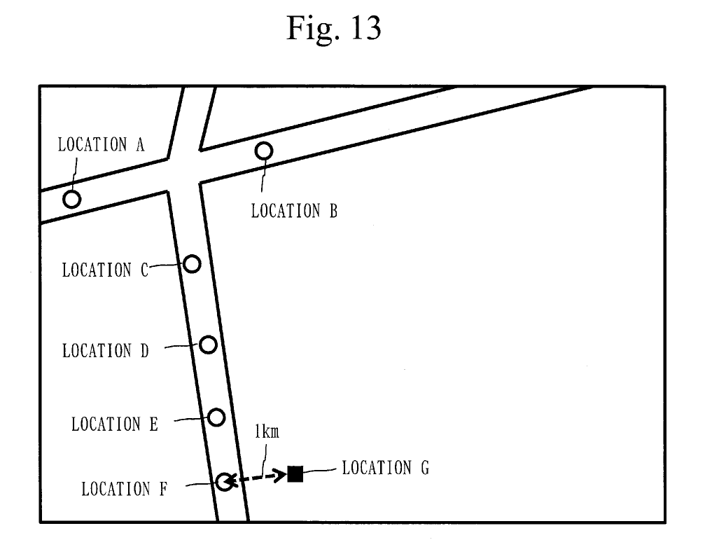

FIG. 13 illustrates a map indicating location A to location G registered in the history file 191 of FIG. 12. Location G for which the search was performed at location F is at a place 1 kilometer away from location F.

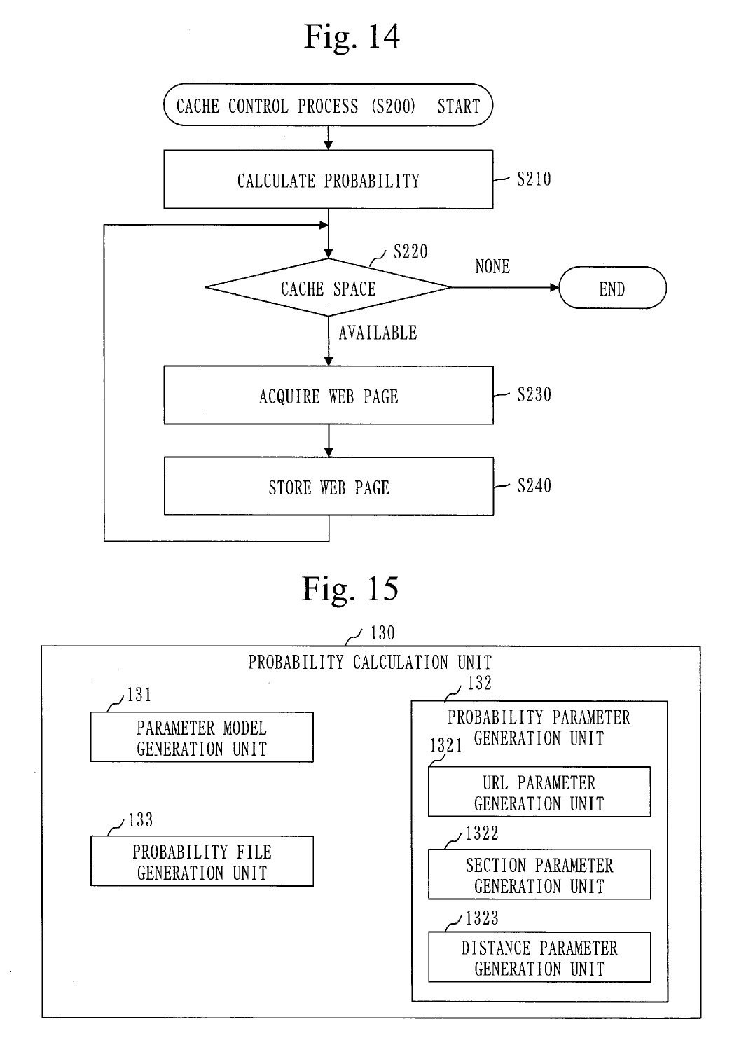

A cache control process (S200) will be described with reference to FIG. 14.

The cache control process (S200) is executed at regular intervals. However, the cache control process (S200) may be executed at predetermined timing, such as when the web browser is activated or when an execution command is input by a user.

S210 is a probability calculation process.

In S210, the probability calculation unit 130 calculates a probability that a link included in a page section will be specified, with regard to each of page sections into which the transition source page is partitioned, using the specified position information registered in the history file 191. Specifically, the probability calculation unit 130 calculates the probability with regard to each page section, based on the number of pieces of coordinate values indicating a position included in this page section out of the coordinate values included in the history file 191.

Further, with regard to each distance range, the probability calculation unit 130 calculates a probability that a search will be performed for a spot whose distance to the web browsing apparatus 100 is included in this distance range, using the number of specified locations whose distance to the current location registered in the history file 191 is included in this distance range, out of the specified locations registered in the history file 191.

The functional configuration of the probability calculation unit 130 will be described with reference to FIG. 15.

The probability calculation unit 130 has a parameter model generation unit 131, a probability parameter generation unit 132, and a probability file generation unit 133.

The parameter model generation unit 131 generates a parameter model 192M, and generates a parameter model file 192 including information on the generated parameter model 192M.

The parameter model 192M is a model in which relations among parameters, such as URLs, page sections, and distance ranges, are indicated in a tree structure. In the parameter model 192M, each parameter is represented by a node in the tree structure.

The probability parameter generation unit 132 generates a probability parameter with regard to each pair of parameters, and generates a probability parameter file 193 indicating the probability parameter for each pair of parameters.

The probability parameter is information indicating a transition source node, a transition destination node, and a probability that an event to make a transition from the transition source node to the transition destination node will occur. A probability may be interpreted as a frequency.

The probability parameter generation unit 132 has a URL parameter generation unit 1321, a section parameter generation unit 1322, and a distance parameter generation unit 1323.

The URL parameter generation unit 1321 generates a probability parameter for a pair in which the transition source node and the transition destination node each represent a URL, out of pairs of the transition source node and the transition destination node. This probability parameter will be called a URL parameter.

The section parameter generation unit 1322 generates a probability parameter for a pair in which the transition source node represents a URL and the transition destination node represents a page section, out of pairs of the transition source node and the transition destination node. This probability parameter will be called a section parameter.

The distance parameter generation unit 1323 generates a probability parameter for a pair in which the transition source node represents a URL and the transition destination node represents a distance range, out of pairs of the transition source node and the transition destination node. This probability parameter will be called a distance parameter.

The probability file generation unit 133 calculates a probability with regard to each parameter, and generates a probability file 194 indicating the probability for each parameter.

If the parameter is a URL, the calculated probability is a probability that a transition will be made to the web page identified by this URL.

If the parameter is a page section, the calculated probability is a probability that a link included in this page section will be specified.

If the parameter is a distance range, the calculated probability is a probability that a search will be performed for a spot whose distance to the web browsing apparatus 100 is included in this distance range.

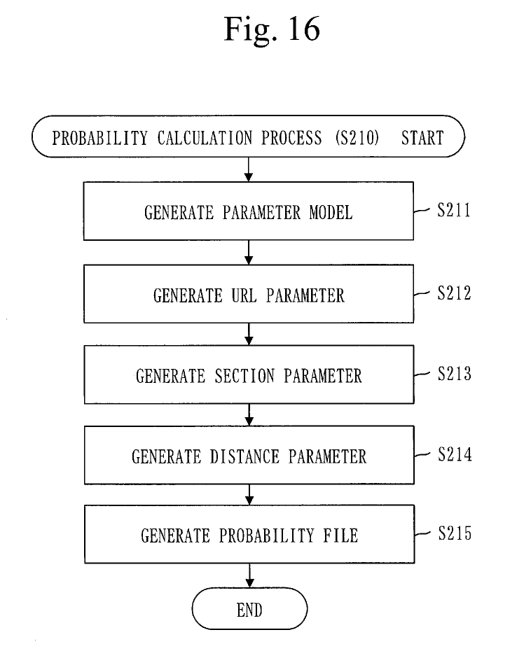

The probability calculation process (S210) will be described in detail with reference to FIG. 16.

In S211, the parameter model generation unit 131 acquires data of the transition source page and data of the transition destination page, and generates the parameter model 192M using the acquired data. The data of each web page may be acquired from any one of the cache memory 9011, the main memory 920, and the web server.

Then, the parameter model generation unit 131 generates the parameter model file 192 including information on the generated parameter model 192M.

Specifically, the parameter model generation unit 131 generates the parameter model 192M as described below.

The parameter model generation unit 131 acquires the URL of the home page from the main memory 920, and generates a parent node representing the acquired URL.

Next, the parameter model generation unit 131 extracts the URL of the transition destination page from the data of the home page, and generates a child node representing the extracted URL.

Next, the parameter model generation unit 131 partitions the transition destination page, and with regard to each page section resulting from partitioning, generates a grandchild node representing the page section.

The parameter model generation unit 131 also generates a grandchild node representing a distance range, with regard to each distance range defined in a distance range file. The distance range file is a file indicating one or more distance ranges, and is pre-stored in the main memory 920.

Then, the parameter model generation unit 131 associates the parent node with the child node, and associates the child node with the grandchild node.

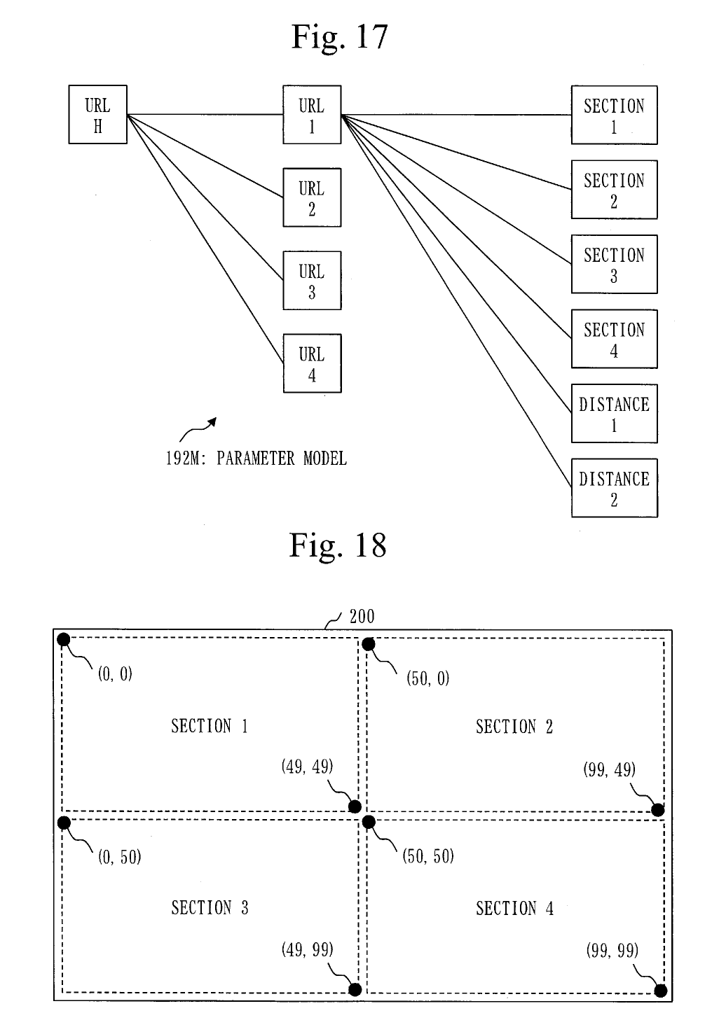

FIG. 17 illustrates an example of the parameter model 192M.

In the parameter model 192M, a parent node representing URLH is associated with child nodes representing URL1 to URL4, and the child node representing URL1 is associated with grandchild nodes representing section 1 to section 4 and grandchild nodes representing distance 1 and distance 2. A line connecting two nodes associated with each other will be called an edge.

FIG. 18 illustrates page sections of the web page 200.

The web page 200 has a size of 100×100 and is partitioned into four page sections.

Section 1 is a rectangular area from coordinates (0, 0) to coordinates (49, 49). Section 2 is a rectangular area from coordinates (50, 0) to coordinates (99, 49). Section 3 is a rectangular area from coordinates (0, 50) to coordinates (49, 99). Section 4 is a rectangular area from coordinates (50, 50) to coordinates (99, 99).

Referring back to FIG. 16, the description continues from S212.

In S212, the URL parameter generation unit 1321 generates a URL parameter using the history file 191 and the parameter model file 192. Then, the URL parameter generation unit 1321 registers the URL parameter in the probability parameter file 193.

Specifically, the URL parameter generation unit 1321 generates the URL parameter as described below.

The URL parameter generation unit 1321 selects a pair in which the transition source node and the transition destination node each represent a URL, from the pairs of the transition source node and the transition destination node included in the parameter model 192M. The selected pair is the transition source node and the transition destination node that are included in the URL parameter.

Next, the URL parameter generation unit 1321 extracts from the history file 191 each row in which the transition source corresponding to the transition source node of the selected pair is set, and counts the number of extracted rows. This number will be called a transition source count. The set of the extracted rows will be called a transition source row set.

Next, the URL parameter generation unit 1321 extracts from the transition source row set each row in which the transition destination corresponding to the transition destination node of the selected pair is set, and counts the number of extracted rows. This number will be called a transition destination count.

Then, the URL parameter generation unit 1321 calculates, as a probability value, a value obtained by dividing the transition destination count by the transition source count.

In S213, the section parameter generation unit 1322 generates a section parameter using the history file 191 and the parameter model file 192. Then, the section parameter generation unit 1322 registers the section parameter in the probability parameter file 193.

Specifically, the section parameter generation unit 1322 generates the section parameter as described below.

The section parameter generation unit 1322 selects a pair in which the transition source node represents a URL and the transition destination node represents a page section, from the pairs of the transition source node and the transition destination node included in the parameter model 192M. The selected pair is the transition source node and the transition destination node that are included in the section parameter.

Next, the section parameter generation unit 1322 extracts from the history file 191 each row in which the transition source corresponding to the transition source node of the selected pair is set, and counts the number of extracted rows. This number will be called a transition source count. The set of the extracted rows will be called a transition source row set.

Next, the section parameter generation unit 1322 extracts from the transition source row set each row in which a specified position included in the page section represented by the transition destination node of the selected pair is set, and counts the number of extracted rows. This number will be called a transition destination count.

Then, the section parameter generation unit 1322 calculates, as a probability value, a value obtained by dividing the transition destination count by the transition source count.

In S214, the distance parameter generation unit 1323 generates a distance parameter using the history file 191 and the parameter model file 192. Then, the distance parameter generation unit 1323 registers the distance parameter in the probability parameter file 193.

Specifically, the distance parameter generation unit 1323 generates the distance parameter as described below.

The distance parameter generation unit 1323 selects a pair in which the transition source node represents a URL and the transition destination node represents a distance range, from the pairs of the transition source node and the transition destination node included in the parameter model 192M. The selected pair is the transition source node and the transition destination node that are included in the distance parameter.

Next, the distance parameter generation unit 1323 extracts from the history file 191 each row in which the transition source corresponding to the transition source node of the selected pair is set, and counts the number of extracted rows. This number will be called a transition source count. The extracted row will be called a transition source row, and the set of transition source rows will be called a transition source row set.

Next, the distance parameter generation unit 1323 acquires the current location and the specified location from the transition source row and calculates a distance from the current location to the specified location, with regard to each transition source row. This distance will be called a specified location distance.

Next, the distance parameter generation unit 1323 extracts from the transition source row set each transition source row corresponding to a specified location distance included in the distance range represented by the transition destination node of the selected pair, and counts the number of extracted rows. This number will be called a transition destination count.

Then, the distance parameter generation unit 1323 calculates, as a probability value, a value obtained by dividing the transition destination count by the transition source count.

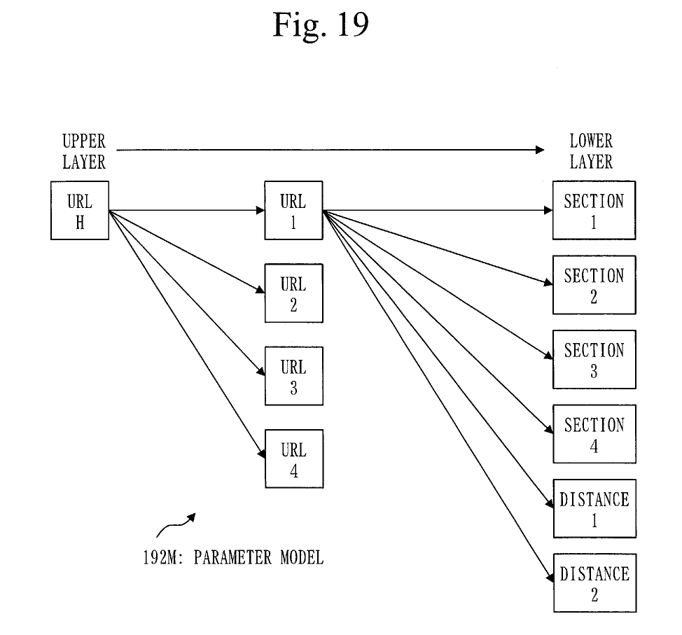

In FIG. 19, it is assumed that the parameter model 192M is a valid graph. That is, the parameter model 192M is a model in which a transition occurs from an upper layer to a lower layer, but no transition occurs from a lower layer to an upper layer.

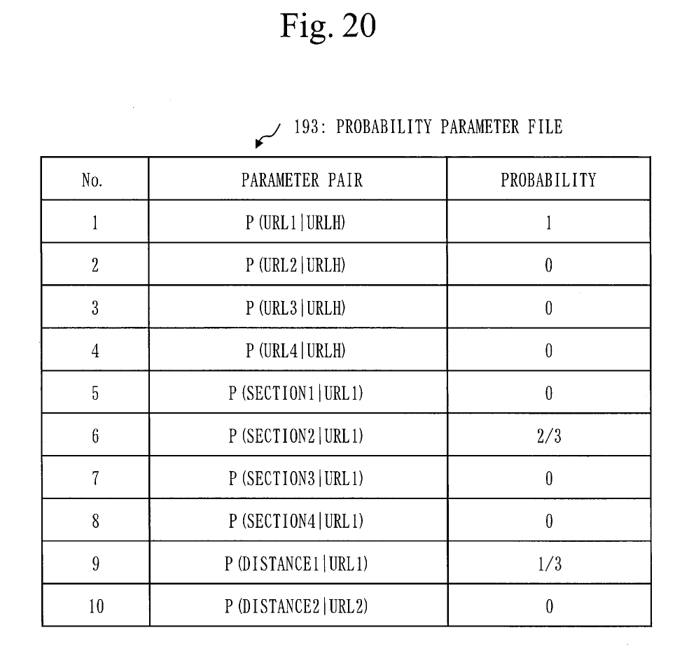

FIG. 20 illustrates the probability parameter file 193 generated using the history file 191 of FIG. 12 and the parameter model 192M of FIG. 19.

In the probability parameter file 193, No., a parameter pair, and a probability are associated with one another.

The No. column indicates a number that identifies the parameter pair and the probability.

The parameter pair column indicates the transition source node and the transition destination node. P(y|x) denotes a probability that a transition will be made from transition source node x to transition destination node y.

The probability column indicates a probability that a transition will be made from the transition source node to the transition destination node.

Referring back to FIG. 16, the description continues from S215.

In S215, the probability file generation unit 133 calculates a probability with regard to each parameter using the probability parameter file 193. Then, the probability file generation unit 133 registers the probability for each parameter in the probability file 194.

The probability for each parameter can be calculated using a Markov model. However, the probability for each parameter may be calculated using a method such as logistic regression or a Bayesian network.

Specifically, the probability file generation unit 133 calculates probability P(N) for a parameter represented by node N by calculating the following equation (1). However, it is assumed that the probability for a parameter represented by a root node having no parent node is 1.

Note that adjacent(N) denotes a set of adjacent nodes each connected to node N with an edge.

$$\begin{matrix}[ Formula 1 ] & \\ P ( N ) = {\sum }_{i ∈ adjacent ( N )} P ( N \vert i ) P ( i ) & ( 1 )\end{matrix}$$

When probability P(section x) is calculated using the probability parameter file 193 of FIG. 20, the equation to calculate the probability P(section x) can be represented by the following equation (2). This is because the nodes of section x are associated only with the node of URL1.

[Formula 2]

P(sectionx)=P(sectionx|URL1)P(URL1) (2)

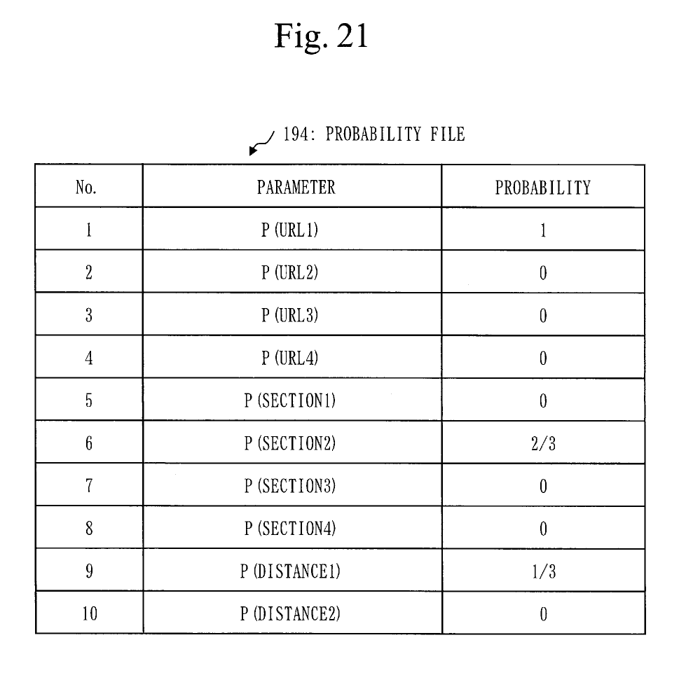

FIG. 21 illustrates the probability file 194 generated using the probability parameter file 193 of FIG. 20.

With reference to FIG. 16, after S215, the probability calculation process (S210) ends.

Referring back to FIG. 14, the description continues from S220.

In S220, the cache unit 150 determines whether a free storage space is available in the cache memory 9011.

If a free storage space is available in the cache memory 9011, the process proceeds to S230.

If no free storage space is available in the cache memory 9011, the cache control process (S200) ends.

S230 is a page acquisition process.

In S230, the page acquisition unit 140 selects a page section based on the probability for each page section, acquires the link included in the selected page section from the transition source page, and acquires the web page associated with the acquired link.

The page acquisition unit 140 also selects a distance range based on the probability for each distance range, and acquires a web page containing information on a place whose distance to the measured current location is included in the selected distance range.

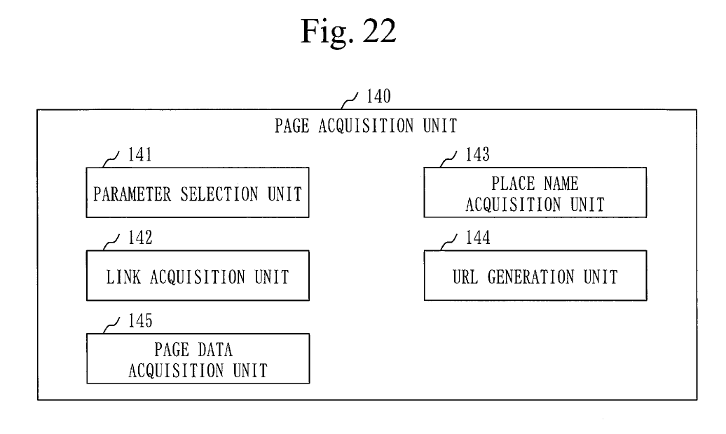

The functional configuration of the page acquisition unit 140 will be described with reference to FIG. 22.

The page acquisition unit 140 has a parameter selection unit 141, a link acquisition unit 142, a place name acquisition unit 143, a URL generation unit 144, and a page data acquisition unit 145.

The parameter selection unit 141 selects a parameter from the probability file 194.

If the selected parameter is a page section, the link acquisition unit 142 acquires the URL indicated by the link included in this page section from the web page.

If the selected parameter is a distance range, the place name acquisition unit 143 acquires the name of a place whose distance from the web browsing apparatus 100 is in this distance range.

The URL generation unit 144 generates a URL of a web page containing information on the identified place.

The page data acquisition unit 145 acquires data of the web page identified by the URL.

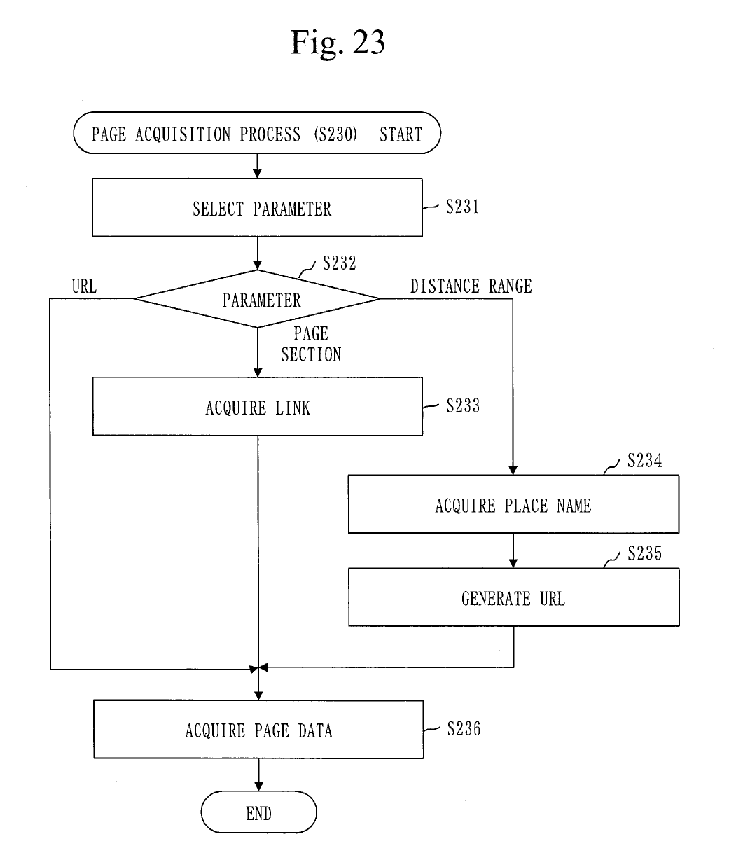

The page acquisition process (S230) will be described in detail with reference to FIG. 23.

In S231, the parameter selection unit 141 selects one parameter from the probability file 194 in descending order of probability.

That is, parameters are selected in order of URL 1, section 2, and distance 1 from the probability file 194 of FIG. 21.

In S232, the parameter selection unit 141 determines the type of the selected parameter.

If the parameter is a URL, the process proceeds to S236.

If the parameter is a page section, the process proceeds to S233.

If the parameter is a distance range, the process proceeds to S234.

In S233, the link acquisition unit 142 identifies the parent node of the selected page section using the parameter model file 192.

Next, the link acquisition unit 142 acquires the URL represented by the identified parent node from the parameter model file 192.

Next, the link acquisition unit 142 acquires data of the parent node identified by the acquired URL from the main memory 920. Note that since the probability for the URL of the parent page is higher than the probability for the page section, the data of the parent page has already been stored in the main memory 920 by S236 to be described later. However, the data of the parent page may be newly acquired from the web server.

Then, the link acquisition unit 142 acquires the link included in the selected page section from the data of the parent page.

In the parameter model 192M of FIG. 17, if the selected parameter is section 2, the URL represented by the parent node is URL1.

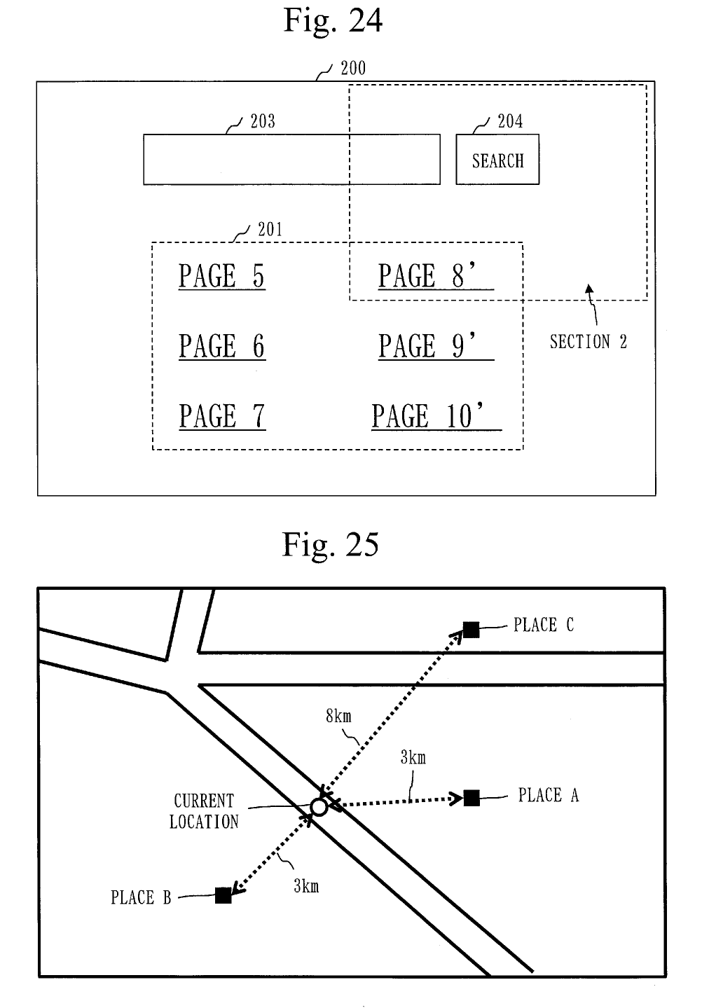

FIG. 24 illustrates a state of the web page 200 identified by URL 1 at 15:00. FIG. 6 illustrates a state of this web page 200 at 14:00. In this case, the links 201 of page 8 to page 10 included in the web page 200 have been changed to the links 201 of page 8′ to page 10′ during a period from 14:00 to 15:00.

In this situation, the link of page 8′ included in section 2 is acquired from the web page 200 of FIG. 24.

Referring back to FIG. 23, the description continues from S234.

In S234, the place name acquisition unit 143 acquires coordinate values indicating the current location of the web browsing apparatus 100 from the positioning device 922.

Next, the place name acquisition unit 143 calculates a distance with regard to each place name included in the place name file, using the coordinate values associated with the place name and the coordinate values indicating the current location.

Then, the place name acquisition unit 143 acquires from the place name file a name of a place whose calculated distance is included in the selected distance range.

FIG. 25 illustrates a map of an area including the current location, place A, place B, and place C.

The distance from place A to the current location is 3 kilometers. The distance from place B to the current location is 3 kilometers. The distance from place C to the current location is 8 kilometers.

If the selected distance range is within 5 kilometers, the name of place A and the name of place B are acquired.

Referring back to FIG. 23, the description continues from S235.

In S235, the URL generation unit 144 identifies the parent node of the selected distance range using the parameter model file 192.

Next, the URL generation unit 144 acquires the URL represented by the identified parent node from the parameter model file 192.

Then, the URL generation unit 144 generates a URL including the place name by adding the place name to the acquired URL.

If the URL of the parent node is http://www.page1.com/ and the acquired place names are place A and place B, a URL http://www.page1.com/?place=place A is generated. Further, a URL http://www.page1.com/?place=place B is generated. Note that a variable name different from “place” may be used. The variable name and each place name that have been encrypted may be set in a URL. Further, instead of a place name, coordinate values may be set in a URL.

In S236, the page data acquisition unit 145 acquires data of the web page identified by the URL, using the URL being the parameter selected in S231, the URL indicated by the link acquired in S233, or the URL generated in S235. Then, the page data acquisition unit 145 stores the acquired data in the main memory 920 in association with the URL.

Specifically, the page data acquisition unit 145 acquires the data of the web page as described below.

The page data acquisition unit 145 generates an HTTP request including the URL, and transmits the generated HTTP request to the web server via the transmitter 9042. HTTP is an abbreviation for HyperText Transfer Protocol.

Then, the page data acquisition unit 145 receives the data of the web page transmitted from the web server via the receiver 9041.

After S236, the page acquisition process (S230) ends.

Referring back to FIG. 14, the description continues from S240. S240 is a cache process.

In S240, the cache unit 150 stores the acquired data of the web page in the cache memory 9011 in association with the URL. The data stored in the cache memory 9011 is the page data 199.

### Effect of Embodiment

The web browsing apparatus 100 calculates a probability that a link included in a page section will be specified, with regard to each page section in a web page. Thus, even if URLs indicated by links change, the web browsing apparatus 100 can store in the cache a web page associated with a link having a high probability of being specified.

The web browsing apparatus 100 calculates a probability that a search will be performed for a place separated only by a distance within a distance range, with regard to each distance range. Thus, the web browsing apparatus 100 can store in the cache a web page related to a place for which there is a high probability that a search will be performed, including places for which a search has never been performed.

***Other Configuration***

The web browsing apparatus 100 may calculate a probability with regard to only one of a page section and a distance range, and cache a web page having a high probability of being accessed.

The main memory 920 may be replaced by a secondary storage device such as a hard disk.

The cache memory 9011 may be replaced by the main memory or the hard disk.

The main memory 920, the cache memory 9011, and the hard disk are examples of a memory. The memory may be interpreted as a storage unit or a storage device.

The functions of the web browsing apparatus 100 may be implemented by hardware.

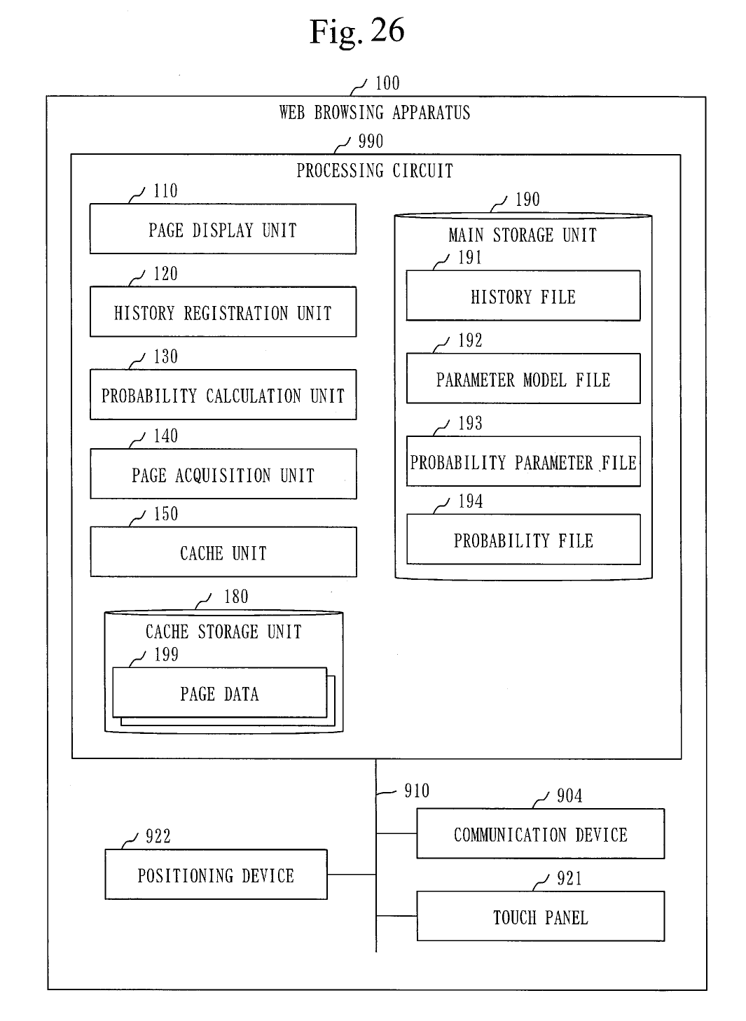

FIG. 26 illustrates the configuration in a case where the functions of the web browsing apparatus 100 are implemented by hardware.

The web browsing apparatus 100 has a processing circuit 990, the communication device 904, the touch panel 921, and the positioning device 922.

These hardware components are connected with the signal line 910. The processing circuit 990 is also referred to as processing circuitry.

The processing circuit 990 is a special-purpose electronic circuit to implement the function of each “unit”, such as the page display unit 110, the history registration unit 120, the probability calculation unit 130, the page acquisition unit 140, the cache unit 150, a cache storage unit 180, and a main storage unit 190.

Specifically, the processing circuit 990 is a single circuit, a composite circuit, a programmed processor, parallel programmed processors, a logic IC, a GA, an ASIC, an FPGA, or a combination of these. GA is an abbreviation for Gate Array. FPGA is an abbreviation for Field Programmable Gate Array. ASIC is an abbreviation for Application Specific Integrated Circuit.

Note that the web browsing apparatus 100 may have a plurality of processing circuits 990, and the plurality of processing circuits 990 may implement the function of each “unit” in cooperation.

The main storage unit 190 and the cache storage unit 180 may be replaced by a primary storage device or a secondary storage device provided externally to the processing circuit 990.

The functions of the web browsing apparatus 100 may be implemented by a combination of software and hardware. That is, the functions of some of the “units” may be implemented by software and the functions of the rest of the “units” may be implemented by hardware.

### Second Embodiment

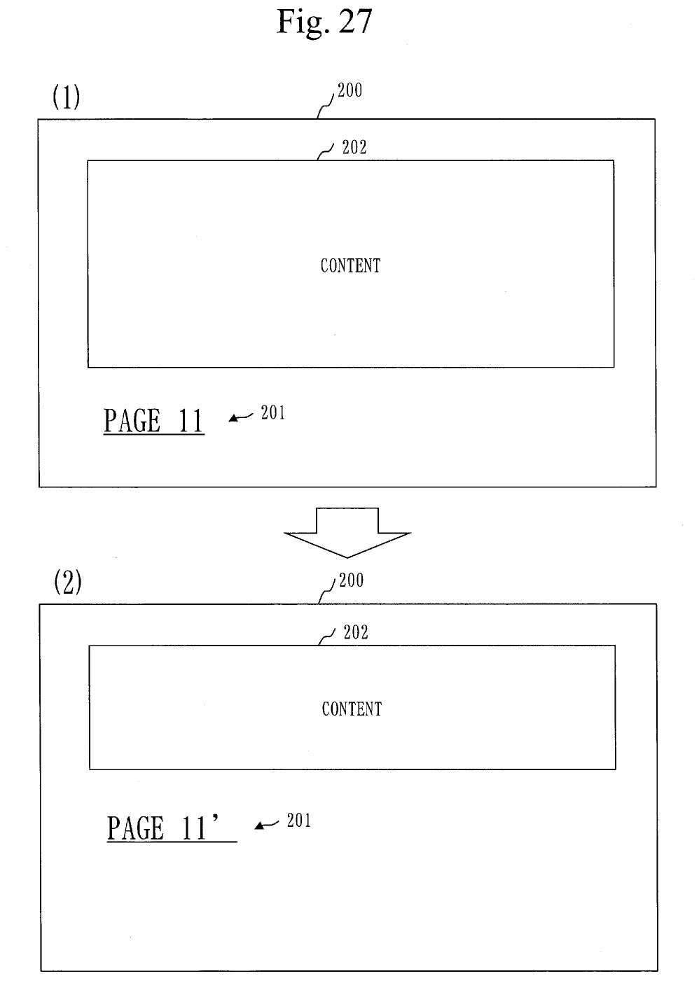

A web browsing apparatus 100 that prefetches and stores in a cache a web page associated with a link having a high probability of being specified even if positions of links included in a web page change will be described with reference to FIG. 27 to FIG. 43. However, a description of what has been described in the first embodiment will be omitted.

FIG. 27 illustrates layouts of a web page 200 at different times.

The web page 200 of (1) is one at 9:00 on May 26, 2015.

The web page 200 of (2) is one at 10:00 on May 26, 2015.

In the two versions of the web page 200, a change has occurred in the display area of content 202, and a change has occurred in the URL of a web page associated with a link 201. Further, with the change in the display area of the content 202, the position of the link 201 has changed. If the content 202 is a document, the display area of the content 202 changes in accordance with a change in length of the document.

***Description of Configuration***

A transition source page is a web page on which a plurality of page sections are arranged and at least one of the page sections includes a link.

Further, the transition source page has a hierarchical structure where a child page section is arranged in a parent page section.

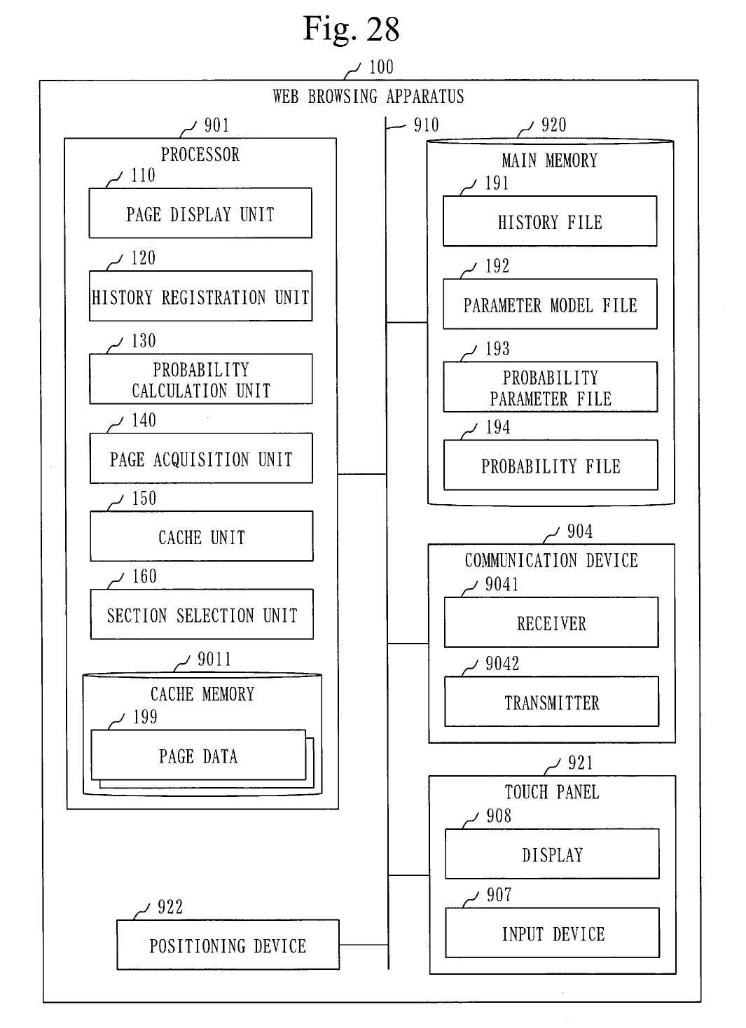

The configuration of the web browsing apparatus 100 will be described with reference to FIG. 28.

A processor 901 executes a program to implement the function of each “unit” including a section selection unit 160. The function of the section selection unit 160 will be described later.

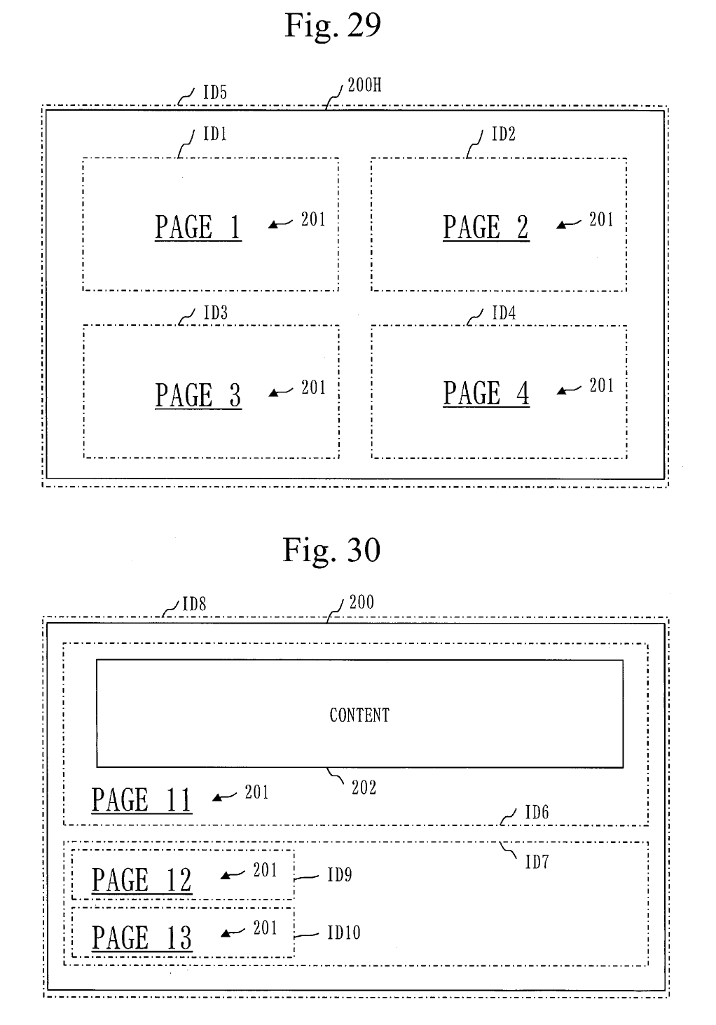

FIG. 29 illustrates the layout of a home page 200H.

The home page 200H has a page section including a link 201 of page 1, a page section including a link 201 of page 2, a page section including a link 201 of page 3, and a page section including a link 201 of page 4.

These four page sections are identified by section identifiers called ID1 to ID4. A page section whose area is the entirety of the home page 200H is identified by a section identifier called ID5. That is, the parent page section identified by ID5 and the child page sections identified by ID1 to ID4 constitute a hierarchical structure.

Specifically, a section identifier is an ID of HTML (HyperText Markup Language). The page section whose area is the entirety of the home page 200H corresponds to an HTML tag or a BODY tag.

FIG. 30 illustrates the layout of a web page 200 associated with the link 201 of page 1.

The web page 200 has a page section including content 202 and a link 201 of page 11 and a page section including a link 201 of page 12 and a link 201 of page 13. These two page sections are identified by section identifiers called ID6 and ID7. A page section whose area is the entirety of the web page 200 is identified by a section identifier called ID8. That is, the parent page section identified by ID8 and the child page sections identified by ID6 and ID7 constitute a hierarchical structure.

Further, the page section identified by ID7 includes a page section including a link 201 of page 12 and a page section including a link 201 of page 13. These two page sections are identified by section identifiers called ID9 and ID10. That is, the parent page section identified by ID7 and the child page sections identified by ID9 and ID10 constitute a hierarchical structure.

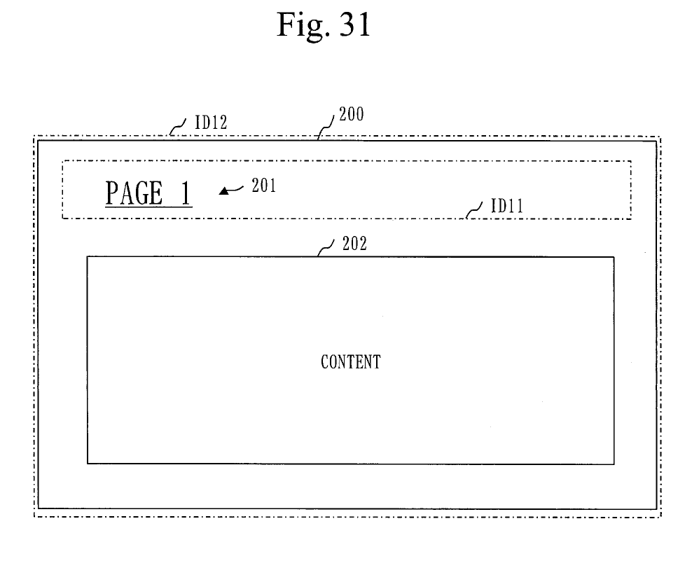

FIG. 31 illustrates the layout of a web page 200 associated with the links 201 of page 11 to page 13.

The web page 200 has a page section including a link 201 of page 1. This page section is identified by a section identifier called ID11. A page section whose area is the entirety of the web page 200 is identified by a section identifier called ID12. That is, the page section identified by ID12 and the page section identified by ID11 constitute a hierarchical structure.

***Description of Operation***

The flow of a web browsing process (S100) is the same as that of the first embodiment (see FIG. 2).

However, the details of a history registration process (S140) are different from those of the first embodiment.

In S140, a specified position registration unit 123 registers, as specified position information, a section identifier that identifies a page section including a specified link in a history file 191.

Specifically, the specified position registration unit 123 registers, in the history file 191, a section identifier set including the section identifier of the page section at each layer including the specified link.

The flow of a history registration process (S140) is the same as that of the first embodiment (see FIG. 10).

However, the details of a specified position registration process (S144) are different from those of the first embodiment.

In S144, the specified position registration unit 123 acquires the section identifier of a page section including a link which has been specified on the transition source page and the section identifier of each page section including the said page section from a page display unit 110.

Then, the specified position registration unit 123 registers a section identifier set including each acquired section identifier in the specified position column of the page display unit 110.

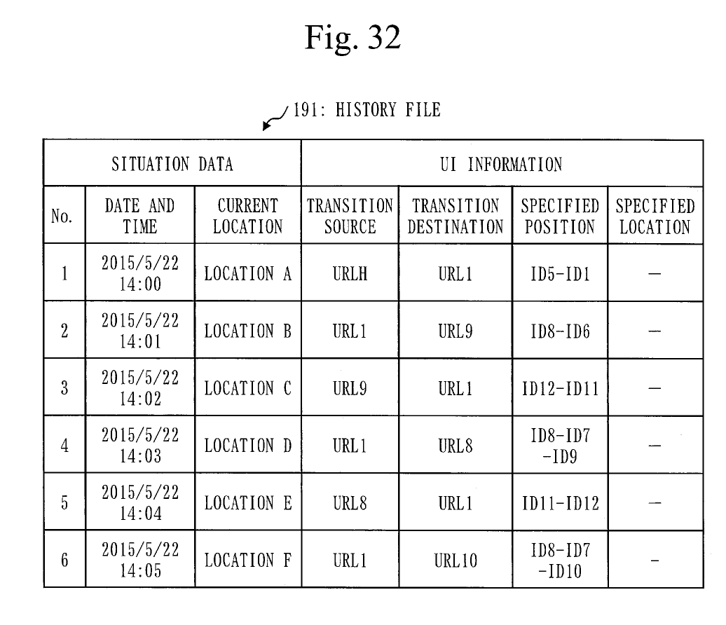

FIG. 32 illustrates an example of the specified position information registered in the history file 191.

The No. 1 row of the history file 191 signifies that on the web page 200 identified by URLH, the link included in page section ID1 contained in page section ID5 has been specified, thereby causing the web page 200 identified by URL1 to be displayed.

The No. 4 row of the history file 191 indicates that the web page 200 identified by URL1 has page section IDS, and page section ID8 includes page section ID7, and page section ID7 includes page section ID9. Further, the No. 4 row signifies that the link included in page section ID9 has been specified, thereby causing the web page identified by URL8 to be displayed.

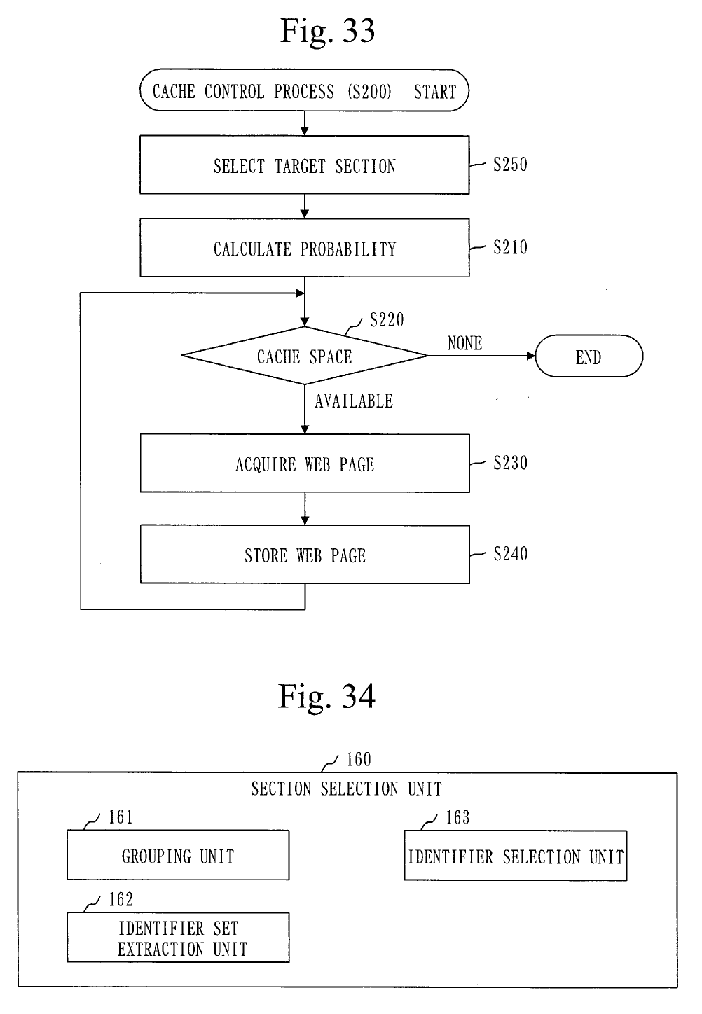

A cache control process (S200) will be described with reference to FIG. 33.

The cache control process (S200) has a section selection process (S250), in addition to the processes of S210 to S240 described in the first embodiment.

In S250, the section selection unit 160 selects a child page section for which a probability is to be calculated, using the section identifier set registered in the history file 191.

The functional configuration of the section selection unit 160 will be described with reference to FIG. 34.

The section selection unit 160 has a grouping unit 161, an identifier set extraction unit 162, and an identifier selection unit 163.

The grouping unit 161 divides the section identifier sets registered in the history file 191 into groups.

With regard to each group, the identifier set extraction unit 162 extracts a common identifier set from each section identifier set in the group, the common identifier set being one or more section identifiers common to each section identifier set.

With regard to each group, the identifier selection unit 163 selects, from the extracted common identifier set, a section identifier that identifies a child page section for which a probability is to be calculated.

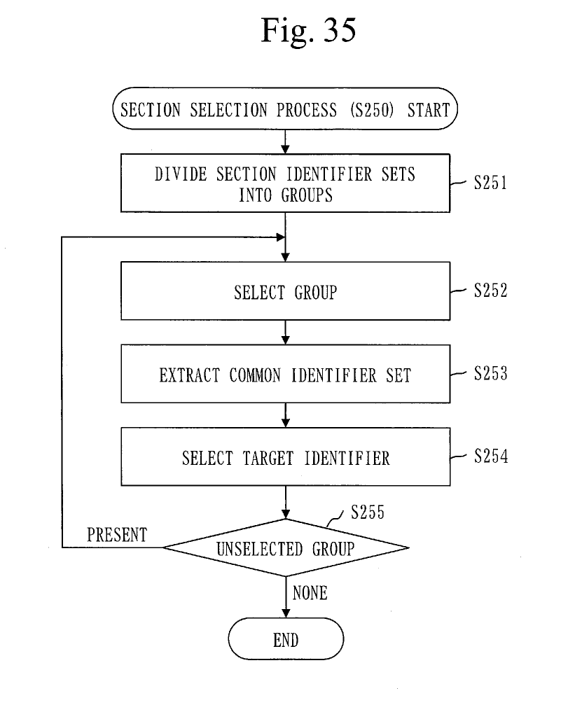

The section selection process (S250) will be described in detail with reference to FIG. 35.

In S251, the grouping unit 161 divides the section identifier sets registered in the history file 191 into groups, and generates a group information file 195 indicating a result of dividing into groups. Dividing into groups means clustering.

Specifically, the grouping unit 161 divides the section identifier sets into groups by a K-means method or another machine learning method. If the K-means method is used, the grouping unit 161 calculates a distance between each pair of section identifier sets by edit distance or another calculation method in order to compare each section identifier set with the other section identifier sets. Then, the grouping unit 161 divides the section identifier sets into groups by the K-means method using the distance between each pair of section identifier sets.

However, if the web page is created in HTML, the grouping unit 161 may divide the section identifier sets into groups based on TLD (Top Level Domain). Alternatively, the grouping unit 161 may divide the section identifier sets into groups by TLD and the machine learning method in combination.

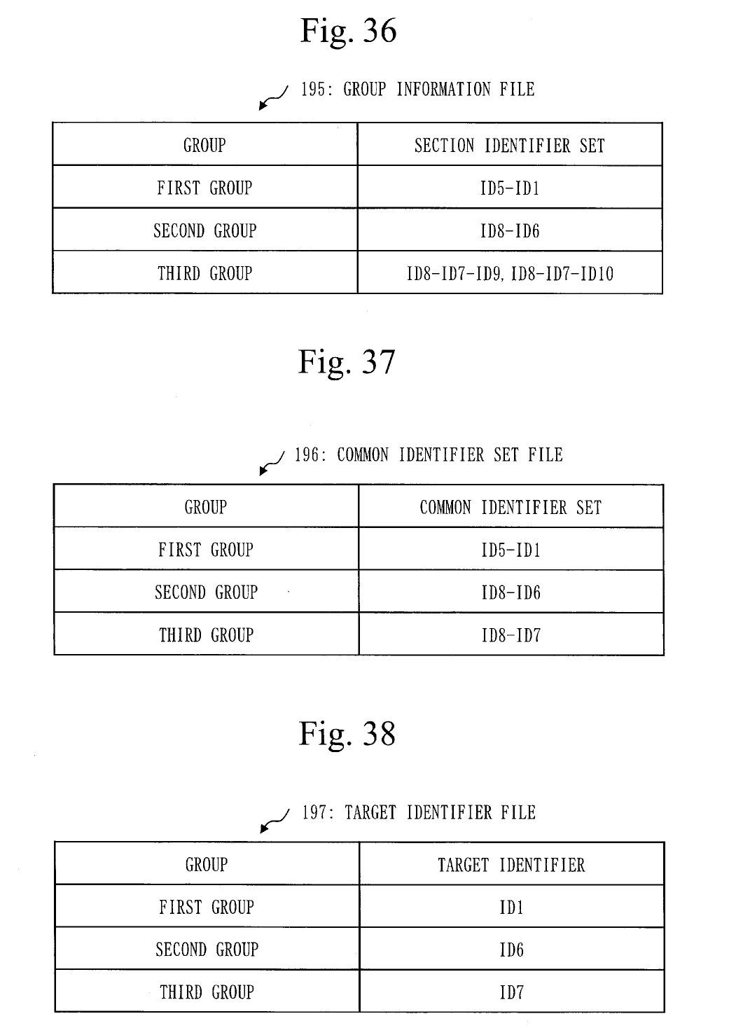

FIG. 36 illustrates the group information file 195 generated using the history file 191 of FIG. 32.

The group information file 195 indicates three groups.

The first group consists of a section identifier set ID5-ID1. The second group consists of a section identifier set ID8-ID6. The third group consists of a section identifier set ID8-ID7-ID9 and a section identifier set ID8-ID7-ID10.

Referring back to FIG. 35, the description continues from S252.

In S252, the grouping unit 161 selects a group which has not been selected from the group information file 195.

In S253, the identifier set extraction unit 162 compares the section identifier sets in the selected group in order from the section identifiers of the uppermost layer, and extracts a successive common portion starting from the section identifier of the uppermost layer, as a common identifier set. Specifically, the identifier set extraction unit 162 extracts the common identifier set by a method called top down mapping or restricted top down mapping.

Then, the identifier set extraction unit 162 registers the extracted common identifier set in a common identifier set file 196.

FIG. 37 illustrates the common identifier set file 196 generated using the group information file 195 of FIG. 36.

In the group information file 195 of FIG. 36, the two section identifier sets belonging to the third group have section identifier ID8 of the first layer and section identifier ID7 of the second layer in common, but have different section identifiers of the third layer. Thus, the common identifier set of the third group is ID8-ID7 as indicated in the common identifier set file 196 of FIG. 37.

Referring back to FIG. 35, the description continues from S254.

In S254, the identifier selection unit 163 selects, as a target identifier, the section identifier of the lowest layer included in the common identifier set. The target identifier is a section identifier for which a probability is to be calculated.

Then, the identifier selection unit 163 registers the selected target identifier in a target identifier file 197.

FIG. 38 illustrates the target identifier file 197 generated using the common identifier set file 196 of FIG. 37.

In the common identifier set file 196 of FIG. 37, the section identifier of the lowest layer in the third group is ID7. Thus, the target identifier of the third group is ID7 as indicated in the target identifier file 197 of FIG. 38.

Referring back to FIG. 35, the description continues from S255.

In S255, the grouping unit 161 determines whether there is a group that has not been selected.

If there is a group that has not been selected, the process returns to S252.

If there is no group that has not been selected, the section selection process (S250) ends.

Referring back to FIG. 33, the description continues from S210.

In S210, the probability calculation unit 130 calculates a probability with regard to each page section, based on the count of the section identifier that identifies this page section out of the section identifiers included in the history file 191.

Specifically, the probability calculation unit 130 calculates a probability with regard to each selected child page section, based on the count of the section identifier that identifies this child page section.

The flow of a probability calculation process (S210) is the same as that of the first embodiment (see FIG. 16).

However, the details of a section parameter generation process (S213) and the details of a probability file generation process (S215) are different from those of the first embodiment.

In S213, a section parameter generation unit 1322 generates a section parameter as described below.

The section parameter generation unit 1322 selects a pair in which the transition source node represents a URL or a page section and the transition destination node represents a page section, from the pairs of the transition source node and the transition destination node included in a parameter model 192M. The selected pair is the transition source node and the transition destination node that are included in the section parameter.

Next, the section parameter generation unit 1322 extracts from the history file 191 each row in which the transition source corresponding to the transition source node of the selected pair is set, and counts the number of extracted rows. This number will be called a transition source count. The set of extracted rows will be called a transition source row set.

Next, the section parameter generation unit 1322 extracts from the transition source row set each row in which the specified position corresponding to the transition destination node of the selected pair is set, and counts the number of extracted rows. This number will be called a transition destination count.

Then, the section parameter generation unit 1322 calculates, as a probability value, a value obtained by dividing the transition destination count by the transition source count.

In S215, the probability file generation unit 133 calculates a probability with regard to each parameter, using the probability parameter file 193. Then, the probability file generation unit 133 registers the probability for each parameter in a probability file 194. The method for calculating a probability is the same as that of the first embodiment.

However, the probability file generation unit 133 calculates the probability for the page section identified by the target identifier indicated in the target identifier file 197, out of all the page sections.

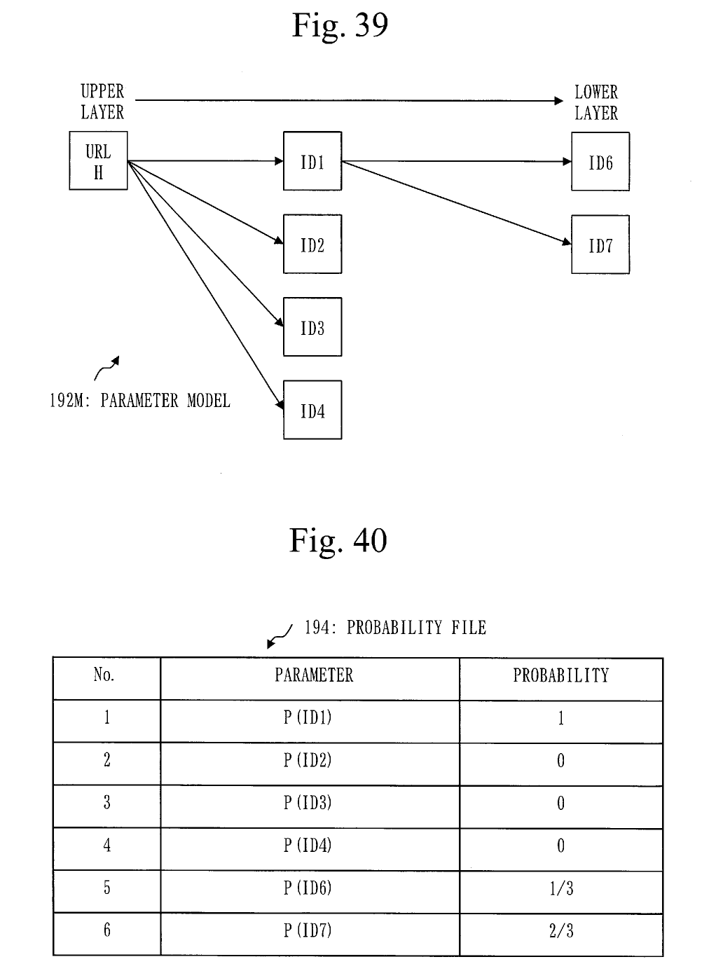

FIG. 39 illustrates an example of the parameter model 192M.

In the parameter model 192M, a parent node representing URLH is associated with child nodes representing ID1 to ID4, and the child node representing ID1 is associated with grandchild nodes representing ID6 and ID7.

FIG. 40 illustrates the probability file 194 generated based on the parameter model 192M of FIG. 39.

### Effect of Embodiment

The web browsing apparatus 100 calculates a probability that a link included in a page section will be specified, with regard to each section identifier. Thus, the web browsing apparatus 100 can store in the cache a web page associated with a link having a high probability of being specified even if positions of links change as the display area of content changes.

The web browsing apparatus 100 divides the section identifier sets into groups. Then, with regard to each group, the web page 200 selects a section identifier of a lower layer, that is, a section identifier that identifies a narrower page section, and calculates a probability with regard to the selected section identifier. With this arrangement, the number of web pages to be stored in the cache is reduced, so that the storage capacity and communication volume for storing web pages in the cache can be reduced.

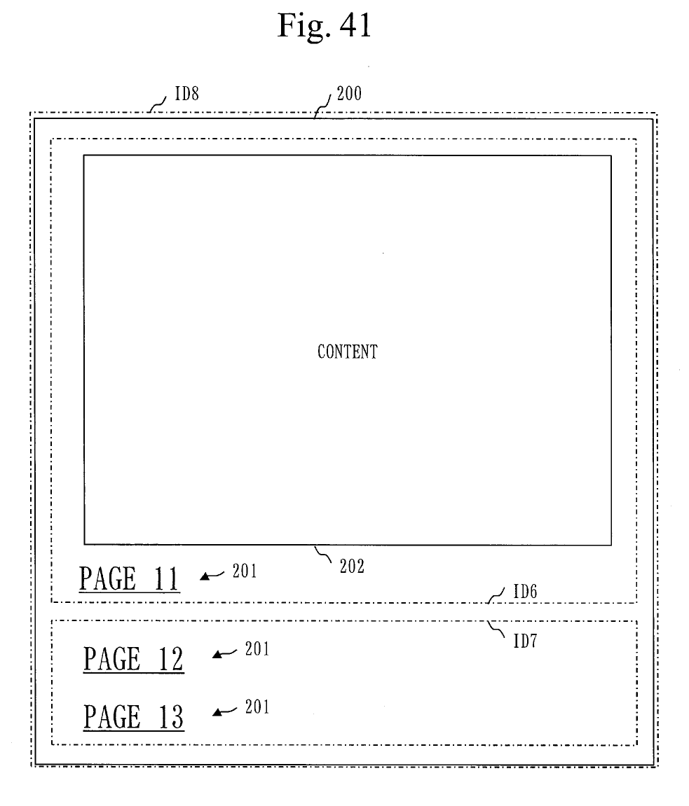

FIG. 41 illustrates the web page 200 on which the positions of the links 201 have changed from the state of FIG. 30.

With the enlargement of the display area of the content 202, the overall size of the web page 200 becomes larger, and the positions of the links 201 have moved to lower portions of the web page 200.

However, with regard to all the links 201, the section identifier of the page section to which each link 201 belongs remains the same.

Thus, by calculating a probability with regard to each section identifier, it is possible to store in the cache a web page associated with a link having a high probability of being specified.

***Other Configuration***

When a web page is created in HTML, section identifiers such as a tag name, an ID name, and a class name, may be used in combination.

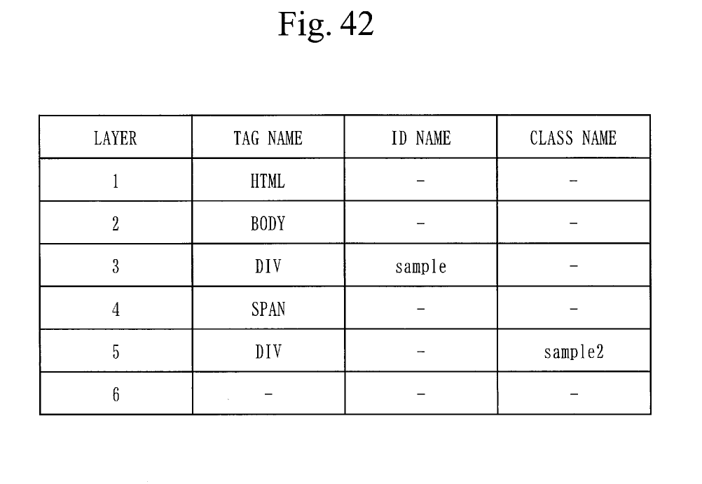

FIG. 42 illustrates relations between these section identifiers and layers of page sections, where “-” denotes that no corresponding section identifier is defined. In this case, the fifth layer is the lowest layer. That is, a page section called DIV and a page section called sample2 which are page sections of the fifth layer are the page sections for which a probability is to be calculated.

The functions of the web browsing apparatus 100 may be implemented by hardware, as in the first embodiment.

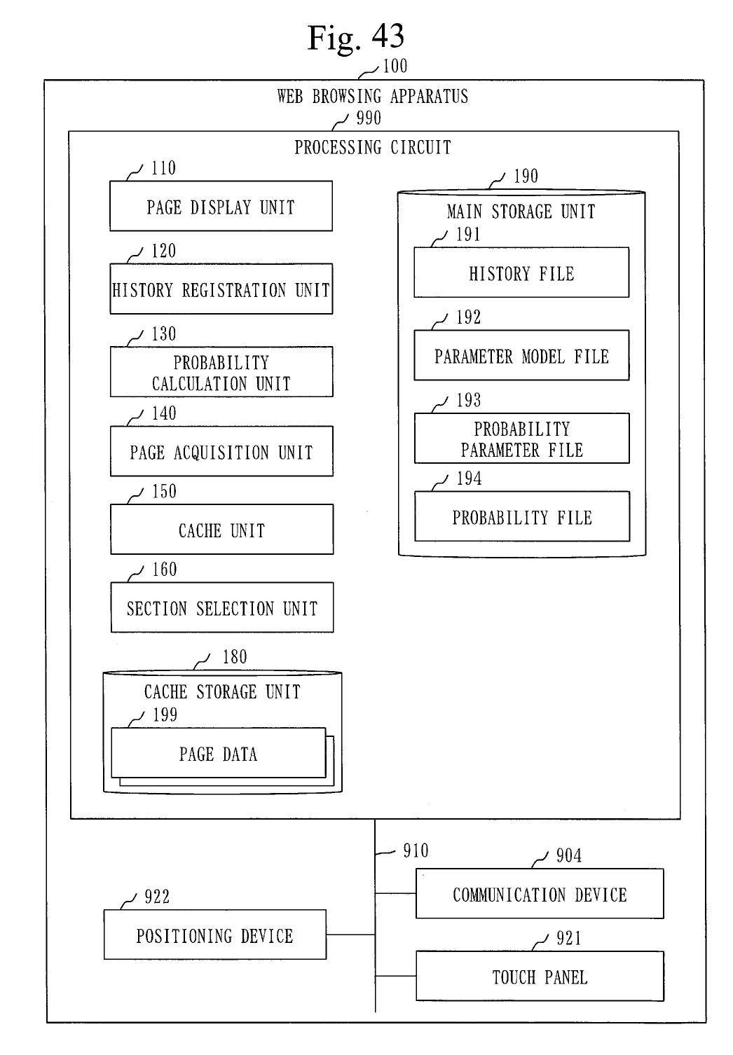

FIG. 43 illustrates the configuration in a case where the functions of the web browsing apparatus 100 are implemented by hardware.

A processing circuit 990 is a special-purpose electronic circuit to implement the function of each “unit” including the section selection unit 160.

Each embodiment is an example of a preferred embodiment, and is not intended to limit the technical scope of the present invention. Each embodiment may be implemented partially, or may be implemented in combination with the other embodiment.

The processing procedures described using the flowcharts or the like are examples of processing procedures of the web browsing apparatus, the web browsing method, and the web browsing program.

### REFERENCE SIGNS LIST

100: web browsing apparatus, 110: page display unit, 120: history registration unit, 121: common information registration unit, 122: operation determination unit, 123: specified position registration unit, 124: specified location registration unit, 130: probability calculation unit, 131: parameter model generation unit, 132: probability parameter generation unit, 1321: URL parameter generation unit, 1322: section parameter generation unit, 1323: distance parameter generation unit, 133: probability file generation unit, 140: page acquisition unit, 141: parameter selection unit, 142: link acquisition unit, 143: place name acquisition unit, 144: URL generation unit, 145: page data acquisition unit, 150: cache unit, 160: section selection unit, 161: grouping unit, 162: identifier set extraction unit, 163: identifier selection unit, 180: cache storage unit, 190: main storage unit, 191: history file, 192: parameter model file, 192M: parameter model, 193: probability parameter file, 194: probability file, 195: group information file, 196: common identifier set file, 197: target identifier file, 199: page data, 200: web page, 200H: home page, 201: link, 202: content, 203: search window, 204: search button, 901: processor, 9011: cache memory, 904: communication device, 9041: receiver, 9042: transmitter, 907: input device, 908: display, 910: signal line, 920: main memory, 921: touch panel, 922: positioning device, 990: processing circuit

1. A web browsing apparatus comprising:
processing circuitry to:
each time a link is specified on a transition source page including a plurality of links associated with other web pages, register specified position information that identifies a specified position on the transition source page in a history file;
calculate, with regard to each page section into which the transition source page is partitioned, a probability that a link included in said page section is specified, using the specified position information registered in the history file;
select a page section based on the probability for each page section, acquire a link included in the selected page section from the transition source page, and acquire a web page associated with the acquired link; and
store the acquired web page in a memory.

2. The web browsing apparatus according to claim 1,
wherein the transition source page is a web page on which a plurality of page sections are arranged and at least one of the page sections includes a link,
wherein the processing circuitry registers, in the history file, a section identifier that identifies a page section including the specified link, as the specified position information, and
calculates the probability with regard to each page section, based on a count of a section identifier that identifies said page section, out of section identifiers included in the history file.

3. The web browsing apparatus according to claim 2,
wherein the transition source page has a hierarchical structure where a child page section is arranged in a parent page section,
wherein the processing circuitry registers, in the history file, a section identifier set including a section identifier of each layer that includes the specified link,
selects a child page section for which the probability is to be calculated, using the section identifier set registered in the history file, and
calculates the probability with regard to each selected child page section, based on a count of a section identifier that identifies said child page section.

4. The web browsing apparatus according to claim 3,
wherein the processing circuitry divides section identifier sets registered in the history file into groups, and
with regard to each group, extracts from section identifier sets in said group a common identifier set being one or more section identifiers common to each section identifier set, and
with regard to each group, selects from the extracted common identifier set a section identifier that identifiers a child page section for which the probability is to be calculated.

5. The web browsing apparatus according to claim 1,
wherein the processing circuitry registers, in the history file, coordinate values indicating the specified position on the transition source page, as the specified position information, and
calculates the probability with regard to each page section, based on a count of pieces of coordinate values indicating a position included in said page section, out of coordinate values included in the history file.

6. The web browsing apparatus according to claim 1,
wherein the web browsing apparatus is a portable device having a function of measuring a current location,
wherein the transition source page is a web page having a search window in which a search keyword is input,
wherein if specified location information that identifies a specified location is input in the search window as the search keyword and a search is performed, the processing circuitry registers, in the history file, coordinate values indicating the specified location identified by the input specified location information and coordinate values indicating the measured current location,
calculates, with regard to each distance range, a probability that a search is performed for a spot whose distance to the web browsing apparatus is included in said distance range, based on a count of a specified location whose distance to the current location registered in the history file is included in said distance range, out of specified locations registered in the history file, and
selects a distance range based on the probability for each distance range, and acquires a web page containing information on a place whose distance to the measured current location is included in the selected distance range.

7. A non-transitory computer readable medium storing a web browsing program for causing a computer to execute:
a history registration process to, each time a link is specified on a transition source page including a plurality of links associated with other web pages, register specified position information that identifies a specified position on the transition source page in a history file;
a probability calculation process to calculate, with regard to each page section into which the transition source page is partitioned, a probability that a link included in said page section is specified, using the specified position information registered in the history file;
a page acquisition process to select a page section based on the probability for each page section, acquire a link included in the selected page section from the transition source page, and acquire a web page associated with the acquired link; and
a cache process to store the acquired web page in a memory.
